(19) United States
(12) Patent Application Publication
(10) Pub. No.: US 2025/0229416 A1
(43) Pub. Date: Jul. 17, 2025

(54) INERTIA-BASED IMPROVEMENTS TO ROBOTS AND ROBOTIC SYSTEMS

(71) Applicant: VANDERBILT UNIVERSITY, Nashville, TN (US)

(72) Inventors: James FERGUSON, Nashville, TN (US); Piper CANNON, Nashville, TN (US); Robert WEBSTER, Nashville, TN (US); Stanley HERRELL, Nashville, TN (US)

(21) Appl. No.: 18/853,029

(22) PCT Filed: Apr. 3, 2023
(86) PCT No.: PCT/US2023/017340

§ 371 Date: Sep. 30, 2024

Related U.S. Application Data
(60) Provisional application No. 63/326,759, filed on Apr. 1, 2022.

(51) Int. Cl. B25J 9/16; B25J 13/08

(52) U.S. Cl. CPC B25J 9/1607; B25J 9/1653; B25J 13/088

(57) ABSTRACT

An Inertial Measurement Unit (IMU) is placed on a robot and outputs inertial information such as angular velocity and linear acceleration of the tip to which it is attached. A robot controller implements a recursive estimation algorithm to fuse robot encoder values with IMU data to determine a statistically optimized estimated position of the robot tip.

### RELATED APPLICATION

This application claims the benefit of U.S. Provisional Application Ser. No. 63/326,759, filed on Apr. 1, 2022, the subject matter of which is hereby incorporated by reference in its entirety.

### GOVERNMENT FUNDING STATEMENT

This invention was made with government support under R01-EB023717 awarded by the National Institutes of Health. The government has certain rights in the invention.

### TECHNICAL FIELD

This disclosure relates to robotics, robotic systems, and the control thereof. More specifically, this disclosure relates to inertia-based improvements to the control of robots and robotic systems.

### BACKGROUND

Current surgical robots are directly controlled by the human surgeon who compensates for robot errors. The robot does not need to “know” its current tip position because, as long as the tip moves in the general direction of the human input motion, the system is usable by a human who can compensate for errors. It is only those instances where a robot is being configured for use without a human in the loop, such as automated procedures/motions or during image guided surgery, that require a high degree of accuracy between the tip position commanded by the robot controller and the actual tip position that is achieved. For robotic surgery, surgical sub-tasks, and image guidance to be automated, it is therefore essential that improved accuracy is achieved.

Surgical robotic instruments are thin instruments that achieve tip articulation from actuation outside the patient. These surgical robots include links connected by joints that facilitate their movement. The joints can be resolute, allowing the joints to rotate, e.g., pivot, about an axis. The joints can also be prismatic, allowing translational movement of the link along an axis. Robots can employ any number of links and any number of joints, resolute and/or prismatic, to achieve the degrees of freedom necessary to provide the desired tip dexterity.

Surgical robots can employ a variety of drive trains, which include an actuator and a linkage that connects the actuator to the robot links. A robot controller operates the actuators to impart movement in the links via the linkages to achieve desired motion at the robot tip. The linkages can include a variety mechanical elements, such as cables, tendons, belts, gear trains, clutches, or any other mechanical means for connecting the actuators to the links. These various drive trains allow for thin surgical instruments that achieve tip articulation from actuation outside the patient.

Robots are subject to errors between the tip position commanded by the controller and the actual position that the tip achieves. These errors can arise from a variety of sources. For example, cable, tendon, and belt drive trains can suffer from backlash and compliance errors (e.g., the cable, tendon, or belt can stretch). Additionally, component wear, friction, and mechanical tolerances (e.g., tolerance stack-up), can also produce errors. Actuators can introduce errors stemming from encoding resolution and zeroing. All of these errors cannot be accounted for in the models the controller uses to determine the tip location. These effects can negatively influence robot accuracy, as the errors are unknown to the robot. Because of this, controlled tip articulation is inherently uncertain.

### SUMMARY

To resolve this uncertainty, Inertial Measurement Unit(s) (IMU) is/are placed at one or more locations along the length of the robotic instrument, such as at the tip of the instrument. An IMU is a small sensor suite capable of outputting inertial information such as angular velocity and linear acceleration. Through software implemented, for example, in the robot controller, the system can be configured to calculate a tip position with improved accuracy by fusing both the position information outputted by the robotic encoders and IMU data produced by the robot motion, thus estimating the tip location. This can be especially beneficial in image guided surgical procedures where the tip location must be precisely known, for calibrating the robot's kinematic parameters, and for error/fault detection.

According to one aspect, a robotic system includes a robot comprising a working portion configured to undergo robotic movement. A controller is configured to command the operation of one or more actuators according to encoder values to cause the robotic movement in order to control the position the working portion. An inertial measurement unit (IMU) is configured to sense physical movements and to provide IMU data to the robot controller indicative of the sensed physical movements. The IMU is fixed to the working portion of the robot. The controller is configured to fuse the encoder values with the IMU data to determine an estimated position of the robot.

According to another aspect, alone or in combination with any other aspect(s), the robot can include a robot arm with a plurality of links interconnected at joints so that the links can move relative to each other. The working portion can be a portion of the robot arm. The operation of the actuators can cause the links to articulate in order to control the position the robot arm. The IMU can be fixed to the robot arm. The estimated position of the robot can be an estimated position of the robot arm.

According other aspects, alone or in combination with any other aspect(s), the working portion can be a tip of the robot arm. Multiple IMUs can be fixed to the robot arm at different locations. An IMU can be fixed to each link.

According to another aspect, alone or in combination with any other aspect(s), the joints can include resolute joints or prismatic joints.

According to other aspects, alone or in combination with any other aspect(s), the system can include linkages connected to the links and the actuators. The actuators can be configured to manipulate the linkages in order to cause the links to move via the joints. The linkages can be at least one of cables, tendons, belts, gear trains, clutches, and linear actuators.

According to another aspect, alone or in combination with any other aspect(s), the robot can be a serial robot.

According to another aspect, alone or in combination with any other aspect(s), the robot can include a movable member supported on a base by a plurality of actuators. The movable member can be movable by the actuators relative to the base. The working portion can be supported on and movable with the movable member. The operation of the actuators can cause the movable member to articulate in order to control the position of the movable member. The estimated position of the robot can be an estimated position of the movable member.

According to other aspects, alone or in combination with any other aspect(s), the working portion can be supported on the movable member. An IMU can be fixed to the movable member. The actuators can comprise prismatic joints.

According to another aspect, alone or in combination with any other aspect(s), the robot can be a parallel robot.

According to other aspects, alone or in combination with any other aspect(s), the controller can be configured to implement a recursive estimation algorithm configured to fuse the encoder values with the IMU data. The recursive estimation algorithm can be configured to statistically optimize the estimated position given the most recently obtained encoder values and IMU data and a previous best estimate of the estimated position.

According to other aspects, alone or in combination with any other aspect(s), the recursive estimation algorithm can include a filter configured to fuse the encoder values with the IMU data. The filter can include a variable trust statistical filter that produces an estimated position of the working portion. The filter can be configured to bias the estimated position based on at least one of historical data and task-specific information comprising sensor noise, calibration, operating conditions, and past performance.

According to another aspect, alone or in combination with any other aspect(s), the controller can be configured to execute the algorithm on an iterative basis in real-time to produce the estimated position in real-time. The estimated position for a current iteration of the algorithm can be is biased based on an estimated position from a previous iteration of the algorithm.

According to another aspect, alone or in combination with any other aspect(s), the filter can be a Kalman filter or a particle filter.

According to other aspects, alone or in combination with any other aspect(s), the working portion can be an ultrasound probe secured to the robot arm, the IMU being fixed to the ultrasound probe. The controller can be configured to calibrate the encoder values with the IMU data by moving the working portion in open space free from interference from outside structures, wherein the IMU data is presumed accurate and is used to calibrate the encoder values in response to detecting a difference between the encoder values and the IMU data.

### BRIEF DESCRIPTION OF THE DRAWINGS

FIGS. 1A and 1B are schematic illustrations of a robotic systems in which a system and method for producing inertia-based improvements are implemented.

FIGS. 2A-2C are block diagrams illustrating data fusion methods that can be implemented in the robotic system of FIGS. 1A and 1B.

FIG. 3 is a schematic diagram illustrating the kinematics of a robot system grasping an ultrasound probe for increased localization accuracy.

FIG. 4 illustrates how error can be introduced into the kinematic model of the system of FIG. 3.

FIG. 5 is a representation of a B-Spline function of a robot calibration and fault detection aspect of the system and method implemented in the robotic system.

FIG. 6 illustrates a diagram showing an example sparsity structure of the full Jacobian ∂e/∂x implemented in the robot calibration and fault detection aspect of the system and method.

FIG. 7 illustrates an optimal trajectory generated for an industrial arm robot.

FIG. 8 illustrates the observability of the robot-IMU system parameters versus trajectory length.

FIG. 9 illustrates robot kinematic error parameters, extrinsic system parameters, and IMU sensor parameters.

FIG. 10 illustrates histograms of errors between the estimated and ground truth system parameters in Monte Carlo simulations.

FIG. 11 illustrates posterior uncertainty of robot length parameters decreasing with trajectory speed.

FIG. 12. illustrates the experimental setup to test a calibration method's ability to improve accuracy of the robot and sensor models.

FIG. 13 illustrates robot translation and rotation accuracy results.

FIG. 14 illustrates histograms showing both specific force and angular velocity sensor accuracy before calibration, after calibration according to the method disclosed herein, and after a standard calibration.

### DESCRIPTION

### Robotic System

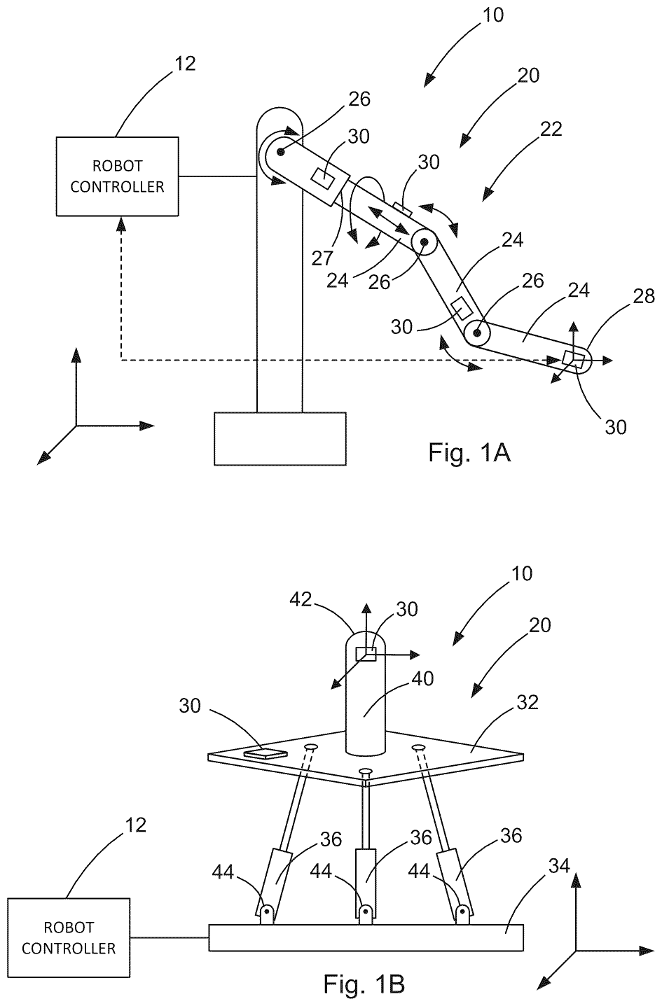

FIGS. 1A and 1B illustrate schematically examples of robotic systems 10, which include a robot 20 and a robot controller 12. In FIG. 1A, the robot 20 is a serial robot that includes an arm 22 with multiple links 24 that are articulated via joints 26, 27 to provide robotic dexterity. The joints 26 are resolute, i.e., they allow the associated links 24 to rotate or pivot about an axis. In FIG. 1A, the arm 22 does include one prismatic joint 27, which allows axial movement of the associated link 24. In doing so, the robot 20 can have multiple degrees of freedom, indicated by arrows which show various movements of the links 24 that are produced by the joints 26, 27. The robot 20 configuration of FIG. 1A is for purposes of illustration only, and the systems and methods disclosed herein are by no means limited to this particular configuration. The systems and methods disclosed herein are applicable to robots 20 and robot systems 10 having any number of links 24, joints 26, 27 and, therefore, any number of degrees of freedom.

The example configuration of the robotic system 10 shown in FIG. 1A is by way of example only. Alternative configurations are not only contemplated, but presumed and, accordingly, the invention disclosed herein should be considered applicable to any robot configuration. The systems and methods disclosed herein are agnostic to the robot configuration. For example, while the robot 20 of FIG. 1A is a serial robot with both resolute and prismatic joints, it should be appreciated that the systems and methods disclosed herein are applicable to serial robots having only resolute joints, only prismatic joints, or any combination thereof.

In the example configuration of FIG. 1A, the robot controller 12 is configured to operate robot actuators (not shown) in a known manner to impart movement of the links 24 via the joints 26, 27. This motion is produced through a drive train that includes a system of linkages that connect the actuators to the links/joints. These linkages can include a variety mechanical elements, such as cables, tendons, belts, gear trains, clutches, linear actuators, or any other mechanical means for connecting the actuators to the links/joints.

The robot 20 of the example robotic system 10 configuration shown in FIG. 1B is a parallel robot. In this configuration, the robot 20 includes a movable member 32 in the form of a platform supported on a base 34 by actuators 36. A tool or tool support 40 is supported on the platform 32 and movable with the platform. The actuators 36 form prismatic joints that are linearly actuatable by the controller 12 to adjust the orientation of the platform 32 relative to the base 34. In doing so, the position of a tip 42 of the tool/tool support 40 is controlled.

In the example configuration of FIG. 1B, the robot controller 12 is configured to operate the actuators 36 in a known manner to impart movement of the platform 32 relative to the base 34. This motion is produced through the combined linear movements of the actuators 36 in combination with pivoting connections 44 with the base (e.g., universal joints) so that the desired movement of the platform 32, and the tool/tool holder 40 is achieved.

Robots are inherently disposed to errors. The controller 12 “knows” precisely the position to which the working end or tip 28 has been commanded via robot motor encoder values. Backlash and compliance errors, component wear, friction, mechanical tolerances, actuator encoding resolution and zeroing all can lead to errors between the commanded position and the actual position that the tip 28 achieves. To account for this, the system 10 implements one or more inertial measurement units (IMUs) 30 configured to measure the rotational and linear movements of the robot arm 22, especially the tip 28, and calculate its position from the measured movements. In the example configuration of the robot system 10 of FIG. 1A, an IMU 30 is connected to each link 24 of the robot arm 22 and can be used to measure the linear/rotational movement of each link. In the example configuration of the robot system 10 of FIG. 1B an IMU 30 is mounted at the tip 42 and on the platform 32. More or fewer IMUs 30 can be implemented. For instance, example configurations described herein implement a single IMU 30 fixed to the tip 28, 42 of the robot 20.

The term “controller” used herein not meant to be singular in nature, as one or more controllers can be implemented in the system 10. Additionally, it should be understood that the robot controller 12 is used in the broadest sense, meaning that it can include any computer or combination of computers configured to perform the methods and other functions described herein.

While this disclosure is directed to determining the location of the robot tip 28, it should be understood that the system and method disclosed herein can be used to determine the location of any part or portion of the robot 20. Since, however, the working portion of most robotic applications is at the tip of the robot, this is the location upon which this disclosure is focused.

The IMU 30 is a small sensor suite capable of outputting inertial information such as angular velocity and linear acceleration. Through software implemented in the robot controller 12, the system 10 can be configured to calculate an estimated position (e.g., tip position) with improved accuracy by taking into account both the position information outputted by the robot 20 and data from the IMU(s) 30 responsive to the actual arm/tip motion. This can be especially beneficial in image guided surgical procedures where the tip location must be precisely known, for calibrating the robot's kinematic parameters, and for error/fault detection.

### Inertial Data Fusion for Robot Accuracy Improvement

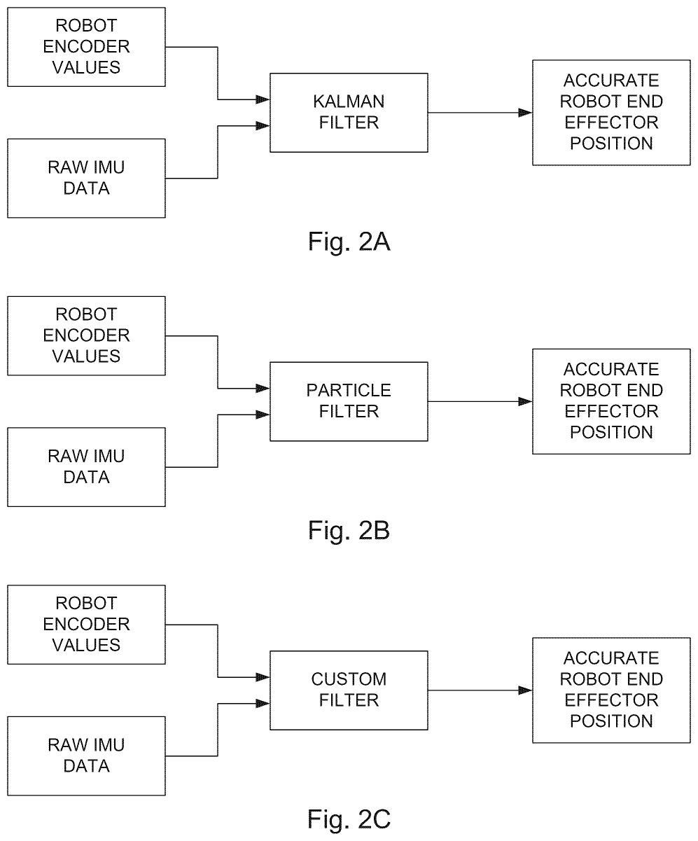

To achieve the best estimate of the instrument tip location, software implemented in the controller fuses the encoder values outputted by the robot (e.g., joint angles) with IMU data in real-time. A filter is implemented to fuse the encoder values and IMU data in a statistically optimal way. The filter is a variable trust statistical filter that produces estimates, which can be biased based on historical data (e.g., previous iterations) and/or task-specific information. As shown in FIGS. 2A-2C, the filtering can be performed by known algorithms, such as Kalman filtering or particle filtering. Custom filters can also be implemented (see FIG. 2C). Such custom filters can, for example, be a Kalman or particle filter that is adjusted or otherwise tailored for a particular robotic system, workspace, application, etc.

The method illustrated in FIGS. 2A-2C implemented in the robot controller software allows for a more accurate estimation of the instrument tip location. This is useful in a surgical setting, where errors can be introduced through interactions with the anatomy). During regular use of a surgical robotic instrument, these interactions are not noteworthy because the surgeon's reaction can account for the interaction. During automated procedures or when employing an image guidance system within the surgical procedure context, accuracy is important. In this case, one must accurately know where the tip of the surgical instrument is to correctly display that information within an image guidance system. By fusing the IMU and robot data real time, this software will allow for a more accurate display of the surgical environment when employing image guidance with a robot. Additionally, the software could be employed to monitor robot faults in real time. Large variance between IMU and robot sensor data may indicate a fault within the robotic system, which is useful in a surgical context.

The software allows the robot controller to fuse IMU data with robot kinematic data to determine the estimated tip position in real-time. To this point, Kalman, particle, and other variable trust statistical filters are particularly adept at facilitating the real-time fusion of data streams from the IMU and the robot. The filtering schemes illustrated in FIGS. 2A-2C implement a recursive estimation framework. At each iteration, given new robot and IMU data (with assumed uncertainties) and the previous best estimate of the state (with uncertainty), a new, statistically optimal estimate of the state is computed. This estimation can be performed online hundreds of times per second as new data comes in to accurately track the tip location. Additionally, the method can keep track of tip location uncertainty, which is useful for evaluation purposes.

The filtering of FIGS. 2A-2C can be performed in a number of ways. For example, one estimation framework could accept the robotic encoder values and the IMU sensor values as input, as shown in the figures. Here, the optimization would be initialized by the joint values as given by the robotic encoders. Using bounded nonlinear least-squares, the framework could estimate the joint values via the Levenberg-Marquardt algorithm, a well known least squares curve fitting algorithm, to iteratively adjust the joint value variables to find the optimal solution. In this case, the optimal solution will be the joint values which produce a tip rotation, via the robot's forward kinematics, that matches the rotational measurement output as given by the IMU. By generating these optimal joint values to match the IMU measurements, both an updated rotation and position of the tool tip are obtained.

As another example, an implementation of the estimation framework could enact the same optimization process but apply various weightings to the robotic encoder and IMU measurements, depending on the situation. Here, rather than only using the robotic encoder values as the initial guess, the framework would prioritize the measurements of the robot over the IMU on a sliding scale. Meaning, at one point in time, the robotic measurements may be “trusted” more than the IMU measurements. Then, at another point in time, the IMU measurements are trusted more. This is referred to as sensor weighting or prioritization.

Under a weighted sensor approach to the estimation framework, each sensor's measurement is assigned a weight based on its reliability or accuracy, and the sensor fusion algorithm takes these weights into account when combining the measurements. The weights can be determined based on various factors such as the sensor's noise characteristics, sensor calibration, operating conditions, and past performance. By assigning different weights to different sensors, the algorithm can give more importance to the sensors with better accuracy or reliability, while reducing the influence of the sensors with higher noise or uncertainty. This can improve the overall accuracy and robustness of the sensor fusion implementation.

The locations of the IMUs are not necessarily limited to locations on the robot arm. This is because the source of position errors is not necessarily limited to errors in the robot structure. For example, during surgery, the patient or the operating table can also move, and this movement can produce errors in the knowledge of the robot location. Thus, IMUs can be fixed to the operating table or even the patient in order to monitor their movement. With this knowledge, the system and method can include these movements in the IMU data that is fused with the robot encoder values to determine the statistically optimized estimated position of the robot.

### Embedded Inertial Measurement Unit in Robot Grasped Ultrasound Probe for Increased Localization Accuracy

In surgical contexts which require imaging information, such as image guidance while using ultrasound data, an accurate knowledge of the instrument tip is required. These procedures can be performed robotically, with the robot grasping an ultrasound probe. In performing such procedures, however, backlash and compliance errors, component wear, friction, mechanical tolerances, actuator encoding resolution and zeroing propagates error in tip location knowledge when probing an anatomical surface with the ultrasound probe. To resolve this uncertainty, the ultrasound probe is fitted with an IMU within the robot grasped ultrasound probe.

By embedding the sensor within the ultrasound probe, IMU data can be used in conjunction with the robot encoder data to more accurately localize points within the ultrasound image. This information is especially useful when employing image guidance within the surgical robot display during a procedure. Accurately locating points within ultrasound images allows for increased knowledge of the location of subsurface structures, which greatly improves the surgeon's situational awareness of the surgical field.

The embedment of an IMU within a robot-held ultrasound probe increases the kinematic accuracy of the robot while the probe is being used to image against anatomical features. The IMU data will be fused with robot kinematic data to overcome the error introduced by the aforementioned sources.

This will, in turn, increase the accuracy of point localization within the ultrasound image. Further, the situational knowledge garnered from the ultrasound image frame can then be used to accurately display subsurface structures in relation to robotic instruments within an image guidance display. Image guidance within surgical robot displays heavily increases the surgeon's situational awareness of the surgical field. This knowledge of the surgical field, however, is limited to what can be viewed by the naked eye or through an endoscope. The addition of the IMU within the ultrasound probe allows for accurate display of subsurface structures within the image guidance context.

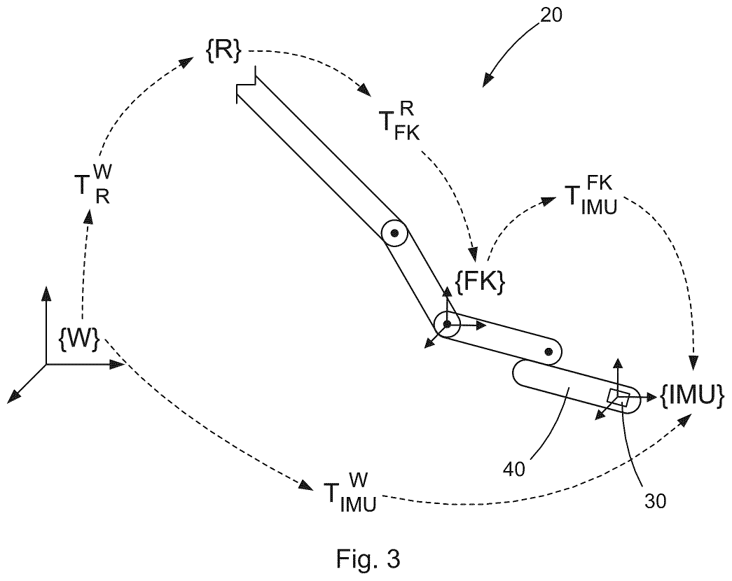

The additional rotational data provided by the IMU can be used to supplement the robot kinematic data in a manner similar or identical to that illustrated in FIG. 3, which shows the robot 20 holding an ultrasound probe 40 fitted with an IMU 30. FIG. 3 also illustrates the following transformations:
The transformation T_{R}^{W} between the world frame {W} and the robot frame {R}.
The transformation T_{FK}^{R} between the robot frame {R} and the robot tool tip frame {FK}.
The transformation T_{IMU}^{FK} between the robot tool tip frame {FK} and the IMU frame {IMU}.
The transformation T_{IMU}^{W} between the world frame {W} and the IMU frame {IMU}.
   The transformation T_{IMU}^{R} between the robot kinematic frame {R} and the IMU frame {IMU} can be used to convey the IMU data in the context of the robot frame.

When probing a surface with the ultrasound, a reactionary force is propagated throughout the joints in the robot's kinematic chain. It is assumed that the joint encoders within the robot cannot accurately account for errors (e.g., backlash and compliance errors, component wear, friction, mechanical tolerances, actuator encoding resolution and zeroing) in these situations. The accuracy of the IMU is not affected by interactions with tissue or other anatomical structures, and is assumed to indicate the orientation of the ultrasound probe accurately. Thus, T_{FK}^{R} and the similar relationship between the ultrasound probe and the robot T_{IMU}^{FK} are used to convey the IMU-given orientation of the ultrasound within the robot frame {R}.

The rotation of the end effector given by the encoders of the robot are compared to that given by the IMU, e.g., according to any of the methods shown in FIGS. 2A-2C. Further, values that the joint encoders would read should they be able to detect the compliance and backlash can be calculated. This information then allows for more accurately locating the position of the robot end effector, e.g., the ultrasound probe.

The ability to accurately locate the position of targets relative to the robot manipulator is not necessarily pertinent to the current surgical robotics standard of care. It is, however, necessary when employing an image guidance system in conjunction with use of the surgical robot. One of the main benefits of an image guidance system is the localization of important anatomical subsurface structures. To garner intraoperative data regarding the location of these subsurface structures, surgeons employ the use of ultrasound. While holding an ultrasound probe with the robotic arm, surgeons can scan relevant anatomy to increase their situational awareness of the surgical field.

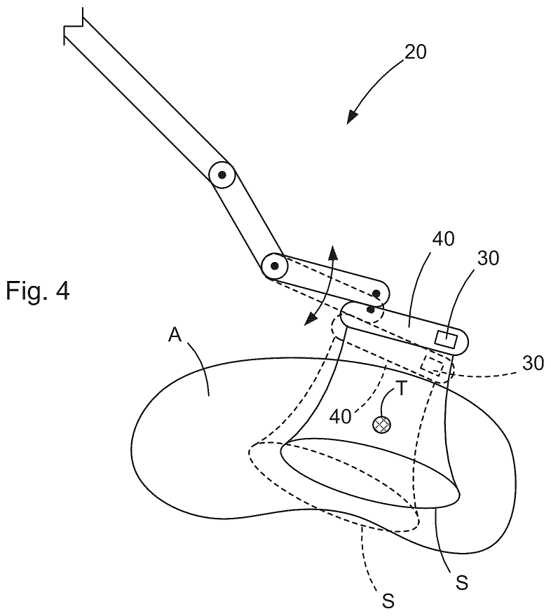

In performing these scans, however, error is introduced into the robot kinematic model. FIG. 4 depicts the error. In FIG. 4, the robot 20 holding the ultrasound probe 40 with the embedded IMU is used to scan (indicated generally by scan area S) an anatomical structure A. In doing so, robot engagement with the anatomical structure A or surrounding tissue can cause the robot arm to deflect, with the result being an error between the robot joint encoder positions (solid lines) and the actual deflected position (dashed lines). As a result, scan area S is shifted, which leads to inaccuracy in the scanned image data. As a result, the relationship between a subsurface target structure T and the robot is unclear.

By incorporating IMU data, this error can be accounted for so that the subsurface structure T can be located and depicted in relation to the robot end effector more accurately.

A preliminary study was conducted using a commercially available surgical robotic system—the Da Vinci® Xi surgical robotic system from Intuitive Surgical, Inc. A custom attachment was built to allow for repeatable grasping of a commercially available ultrasound transducer, such as a BK Medical, Inc. Robotic Drop-In Ultrasound Transducer. Additionally, a Bosch BNO055 inertial measurement unit was rigidly attached to the system. The robot-ultrasound-IMU system was used to locate a pinhead within a gelatin phantom.

Additionally, the location of the pinhead was considered with and without the incorporation of IMU data. The experimental setup and results can be seen in Table 4 below:

TABLE 4
Experimental Ultrasound Probe IMU Results

| IMU? | Average Error (mm) |
|---|---|
| No | 9.7479 |
| Yes | 6.2711 |

As demonstrated by the preliminary experimental results, incorporation of IMU data leads to an accuracy improvement when localizing subsurface points within the ultrasound frame.

To accurately estimate the ultrasound probe location, the data fusion methods described above were implemented. Specifically, the data fusion method implements a recursive estimation framework, such as those shown and described above with reference to FIGS. 2A-2C. Given new robot and IMU data (with assumed uncertainties) and the previous best estimate of the state (with uncertainty), a new, statistically optimal estimate of the state is computed. Again, this estimation can be performed online hundreds of times per second as new data comes in to accurately track the probe location; and the method can keep track of probe location uncertainty which is useful for evaluation purposes.

### Embedded Inertial Measurement Unit in Surgical Robotic Instrument for Robot Calibration and Fault Detection

With surgical robot prevalence within the operating room increasing, the addition of a robot to the surgical team provides many advantages that are presented within the context of manufacturer intended use. However, surgical robots are bringing more advantages that are currently emerging. For instance, using robot data, 3D patient anatomical models can be rendered alongside robotic instruments in an image guidance display. Such display increases the surgeon's awareness of the surgical setting. Furthermore, robotic automation of surgical tasks is being explored in current literature.

These emerging applications require good robot accuracy which can be achieved by robot kinematic calibration. Traditionally, this arduous process requires a high attention to detail and accurate external equipment to collect data for calibration. By imbedding an IMU within the robot arm, this calibration process can be performed quickly and accurately. The predicted inertial quantities (based on robot kinematics) can be compared with the sensed inertial data to determine an accurate robot calibration. This process is fast and can be done automatically, requiring no external calibration equipment in the operating room. This process can, for example be implemented as a fast and automated initial calibration step taken as the robot is turned on.

In addition to robot calibration, an embedded IMU at the tip of a robotic instrument can also be used in monitoring applications such as fault detection. If the robot-predicted inertial quantities do not match the IMU measurements, an alarm can be issued, allowing for the user to further inspect the system. Detecting faults and issuing errors can improve the safety of the robotic device.

By imbedding an IMU within a surgical robotic instrument, the accuracy of robot kinematic parameter estimation can be improved while, at the same time, the robotic system health can be monitored. The inertial data from the highly accurate IMU can be fused with the data from the joint encoders within the robot to provide a multi-source data stream which allows for calibration of robotic parameters. In the regular surgical context, accurate calibration of the robot kinematic parameters is not necessary. However, to employ novel technologies such as image guidance within the surgical robotic system, a highly accurate knowledge of the instrument tip's location must be known and displayed to the surgeon.

Overtime, the health of mechanical hardware, such as joint encoders and actuation devices, can decline due to frequent use. This decrement in quality cannot be reliably measured before true fault occurs. To resolve this issue, the IMU sensor data stream can be monitored continuously to detect a large variance in the location data provided by the IMU and the calculated data provided by the robot. Once a large variance is detected, the system can alert the user to inspect the robot for faults. This improves the overall safety of the surgical robotic system.

According to one aspect, a robot can be calibrated reasonably well using nothing more than the IMU. By waving around the IMU attached to the robot while logging these data, many of the geometric parameters describing the robot can be estimated.

This can be applied to surgical robots that are generally modelled as rigid linkages. Given an IMU embedded in the tip or other locations along the length of a robotic instrument, the method could be used to calibrate a surgical robot upon startup. For example, upon installing a new surgical instrument into the robot, the robot could automatically move itself (and the IMU) along a planned trajectory. Given this recorded data, the robot and instrument could be calibrated quickly. Importantly, this method eschews the need for external tracking/calibration equipment normally needed for calibration.

Given a calibrated robot/IMU, the IMU could be used for monitoring the health of the robotic system. During operation, the values output by the IMU should match the values predicted by the robot's kinematic model to some extent. Fault monitoring with the embedded IMU would involve keeping track of this discrepancy. If, for example, one of the instrument drive chain breaks, the IMU's motion would cease, so its values would no longer match the robot's prediction. This discrepancy could be detected online to issue an error to the user that a fault has occurred.

Both robot and inertial measurement unit (IMU) calibration traditionally involve expensive equipment with many measurements taking considerable time to perform. Uniting these two problems, the many parameters involved when mounting an IMU onto a serial robot's end effector are jointly estimated. In doing so, a self-calibration method provides a fast and accurate alternative to both robot and IMU calibration—all without any external equipment. Importantly, the method also determines the extrinsic sensor parameters required (spatial and temporal offsets, gravity) when using IMUs online for estimation and monitoring applications. Enabled by continuous-time batch estimation, statistically optimal solutions for both the parameters and the actual robot trajectory are determined simultaneously. Under Gaussian assumptions, this leads to a nonlinear least squares problem, analyzing the structure of the associated Jacobian. As the planned trajectory is arbitrary, a sequential method is devised for planning observability-optimal trajectories over the long time scales that the problem demands. While this method is disclosed for the specific purposes of a robot/IMU application, this generalization is straightforward for many other estimation scenarios. The methods are validated both numerically and with experimental data showing that good robot and IMU accuracy can be achieved in five minutes using an inexpensive IMU.

### I. Calibration and Fault Detection—Introduction

Robot calibration is the process of estimating a more accurate kinematic model from a set of observations. Usually, a set of model parameters (e.g. link lengths, joint angle offsets) describing a robot's geometry is inferred with high accuracy based on measured end effector poses when the robot is commanded to known configurations. These model parameters are typically known with some level of certainty a priori. Calibration methods update the model parameters to improve their certainty. As a result, the model's accuracy in predicting the location of the robot's end effector is also improved. With calibration, a robot is improved in software—no hardware or design upgrades are necessary. This ability to make substantial improvements essentially for free has made calibration a rich and mature research area in robotics.

Especially useful for mobile robots, inertial measurement units (IMU) can provide real-time measurements of the kinematic state of a system useful for online estimation and feedback control. Micro-electro-mechanical systems (MEMS) based IMUs are generally equipped with some combination of triaxial accelerometers, gyroscopes, and magnetometers. This useful motion information comes at a small cost—MEMS IMUs are compact, and furthermore, because they are manufactured as a single integrated circuit, they are generally inexpensive. These two facts make IMUs integrable into the vast majority of robotic systems; however, their use naturally presents a calibration problem. The spatial relationships (i.e. the rotation and translation) between the IMU and the robot's coordinate system must be determined before use. Furthermore, the MEMS sensors in IMUs present their own set of intrinsic parameters that must also be calibrated. These nonzero sensor biases, non-unit scale factors, and sensor axis misalignments should all be identified prior to IMU use.

Compared with robot calibration, data collection for IMU calibration is often less straightforward. This is because—neglecting the potential triaxial magnetometer—IMU calibration actually comprises two subproblems: accelerometer and gyroscope calibration. In a laboratory setting, the standard methodology for calibration of IMUs requires mounting the IMU on a leveled turntable. The turntable is then commanded to a precise angular rate, and the IMU sensors are sampled. Calibration is achieved by comparing the gyroscope and accelerometer outputs to known values based on the speed of the leveled turntable and Earth's gravity. Calibration schemes have also been developed for IMUs which do not require any external equipment; however, in these methods, full gyroscope calibration is not usually possible. One reason for this is that without any external equipment, gyroscope calibration is typically based on the known value of Earth's angular velocity. This relatively small value generally leads to numerical issues upon attempting full gyroscope calibration.

The methods disclosed herein for infield (equipment-free) IMU calibration rely on only the Earth's gravity as a reference. Basically, the accelerometer triad is calibrated first by comparing its static outputs to gravity. Then, the gyroscope outputs are integrated during arbitrary motions to determine the final direction of gravity. The difference between this gyroscope-integrated gravity vector and the accelerometer measured gravity vector is then the basis for gyroscope calibration. While these integration-based methods show promise for IMU calibration, they still have drawbacks. First, they require many more manual, unique repositionings of the IMU than methods that do use external equipment. Additionally, because the accelerometer is calibrated first in these methods, the quality of gyroscope calibration is directly dependent on the accelerometer calibration. This does not lead to a globally optimal solution across all the available parameters, and accuracy is impeded by the inherent noise in accelerometer measurements. Ultimately, for IMU calibration, this makes it so that expensive mechanical platforms are often inevitable today.

A final confounding factor in IMU calibration is that the parameters in MEMS devices vary with time and are highly dependent on environmental conditions such as temperature. Thus, MEMS IMUs must be recalibrated periodically; this is especially undesirable in robotics applications since this would require removal of the IMU, mounting on a turntable for calibration, and reinstallation into the robot arm, potentially altering the calibrated mounting position of the IMU relative to the robot.

Accordingly, a new method estimates the many parameters involved when mounting an IMU onto a serial robot's end effector without any external equipment (i.e., self-calibration). The robot's encoders and data output from the IMU are sampled while the robot moves continuously. The resulting time series is used to infer the following parameters: (i.) robot kinematic parameters, (ii.) IMU intrinsic parameters (i.e., sensor gains, biases, and misalignments), and (iii.) extrinsic system parameters (i.e., sensor rotation, translation, temporal offset, and gravity).

Enabled by recent advancements in continuous-time batch estimation, the method also jointly estimates the robot's trajectory. This approach provides seamless trajectory differentiation as well as simple incorporation of temporal offsets into the estimation problem. More importantly, it enables maximum a posteriori (MAP) estimates of the system parameters and the trajectory simultaneously given the sampled data. Under Gaussian assumptions, this leads to a nonlinear least squares problem and the structure of the associated Jacobian can be analyzed.

Finally, as the planned robot trajectory is arbitrary, a sequential method is implemented for generating optimal trajectory plans over the long time scales that the problem demands. The sequential approach makes solutions to a computationally intractable optimization problem feasible. Enabled by the local support of B-splines, the time domain is partitioned into intervals for sequential determination of the trajectory. Given the optimal trajectory in all previous intervals, the trajectory in the next interval is designed optimally, minimizing posterior parameter uncertainty. The methods are validated in simulation and with experimental data collected with an AUBO i5 collaborative industrial robot (AUBO Robotics, USA). Additionally, the calibration method is compared to standard methods for both robot and IMU calibration.

This unified calibration approach is useful for three main scenarios. First, the approach enables a fast and inexpensive alternative to traditional robot calibration, especially when angular parameters are particularly uncertain. Calibration equipment (e.g., optical/laser tracking systems) is often expensive, and data collection is often cited as the most time-consuming part of calibration. The sensor used in experiments cost less than $30 USD, and automatic data collection took only five minutes. Second, the method enables an automated alternative to traditional IMU calibration which circumvents the need for external calibration equipment (provided that a robot is also available).

Finally, the method enables an essential calibration step for online robot estimation and monitoring applications using IMUs. For example, IMUs have been explored as a primary means of measuring robot joint angles. More recently, data from IMUs has been fused with encoder data to increase robot accuracy online. Additionally, IMUs have been used for robot collision monitoring and could be applied to general fault detection. In order to use an IMU in these applications, many extrinsic parameters (e.g., rotation and translation of the IMU relative to the end-effector) must first be determined. Furthermore, the method eschews removal of the IMU from the robot to achieve an accurate IMU calibration; this is especially useful since frequent recalibration of sensor parameters is often unavoidable.

### II. Related Work on Robot/IMU Calibration

While IMUs have seen extensive application in mobile robotics, their use has been more limited in fixed-base robot manipulators. Among the literature, related works concerning calibration with IMU-equipped stationary robots can placed into one of three general categories: (i) use of IMUs for robot calibration, (ii) use of robots for IMU calibration, and (iii) those that must calibrate the spatial offset of the IMU relative to the end effector for use in estimation. While robot calibration is typically carried out using camera systems, laser trackers, or by probing reference geometry, some research groups have instead attempted to use an IMU as the main data source for calibration. Importantly, however, in all of these works, measurements were only taken under static conditions.

According to the method disclosed herein, the data is sampled while the robot moves continuously. The reason for this is twofold. First, it enables the collection of much more data in the same amount of time. Second, and importantly, the data collected under dynamic conditions is potentially more informative. During motion, the acceleration and angular velocity of the end effector can be measured. If the robot is stationary, these quantities are all zero.

Additionally, another fact that is central to all of the related works is that, in order to use an IMU for robot calibration, its sensor parameters must first be calibrated. In each of the aforementioned works, the IMU sensors were either calibrated beforehand or nominal values were used instead. However, calibration of the IMU sensors adds an extra step to the robot calibration procedure, and foregoing calibration in favor of nominal parameters could lead to inaccuracy as MEMS sensor parameters are known to change over time. In contrast, the present method jointly estimates the robot and IMU parameters in one fast and accurate calibration step.

While IMU calibration is typically conducted using turntables, comparing outputs to gravity, or by camera-based sensor fusion methods, some researchers have instead opted to use robots. In one instance, the authors present a method using a robot to calibrate an end effector-mounted accelerometer and magnetometer. Calibration of IMU gyroscopes, however, is not presented. In another instance, an open source, low cost robot is used for calibration of IMUs. In another instance, calibration of only the triaxial accelerometer portion of the IMU is performed using a serial robot. In this online method, the current parameter covariance matrix is used to optimize the next measurement orientation. While these methods were able to calibrate at least some of the IMU sensors using a robot arm with good results, they all suffer from two main issues. First, as the robot was not in motion during data collection, many of the gyroscope parameters could not be estimated. Second, any robot-based IMU calibration method could be improved with a more accurate robot. According to the disclosed method, as the robot is moving, all of the sensor parameters of interest can be calibrated. Furthermore, the disclosed method also simultaneously calibrates the robot, which makes the method potentially more accurate for IMU calibration as an inaccurate robot could lead to an inaccurate IMU calibration.

Most applications of IMUs in robotics are limited to visual-inertial navigation and mobile robots. Some researchers, however, have instead attempted to use IMU data with stationary robots. One application that has received considerable attention is using inertial sensors for joint angle measurement instead of traditional angle transducers (e.g., encoders). In one instance, the joint angles of a robot are measured using 2-axis accelerometers with a static accelerometer calibration scheme to estimate voltage biases. In another instance a method estimates joint angles of an industrial robot using multiple IMUs. In order to use the sensors for estimation, several of the gyroscope parameters were first calibrated by moving the robot dynamically, and the accelerometer parameters were then calibrated while the robot was stationary by comparing the sensor outputs to gravity. In another instance, IMUs were used for joint angle estimation comparing a complementary filter, a time-varying complementary filter, and an extended Kalman filter with good results. A necessary step was the calibration of the sensor spatial offset. In yet another instance, IMUs were used for human joint angle estimation, such as computing gait angles or the orientation of human body limbs.

Furthermore, instead of using IMUs as a primary means of joint angle sensing, more recently, some research has attempted to fuse encoder and IMU data together to increase robot accuracy. In one instance, both Kalman and particle filters accurately estimate the state of the end effector by fusing IMU and encoder data. A calibration method estimates the spatial offset of the IMU relative to the end effector. These sensor fusion methods did improve robot accuracy. In another instance joint angles, velocities, and accelerations were estimated by fusing IMU and encoder data without any calibration of sensor parameters.

Many of the known applications of inertial sensors for stationary robot estimation do not discuss calibration at all, and those that do discuss calibration primarily focus on estimation of the spatial offset between the IMU and the end effector. The disclosed method, justified by the rigorous MAP framework, estimates this kinematic offset, but also all of the relevant sensor and robot parameters.

While there are many methods to estimate temporal offsets between sensors, the unified calibration method builds on recent advancements in continuous time batch estimation in order to account for time offsets and differing sample rates between the data streams. This flexible approach is particularly convenient as representing the robot trajectory as a sum of B-splines implies fast and accurate derivative calculations which are necessary for predicting angular velocities and linear accelerations output by the IMU.

### III. Robot and Inertial Sensor Models

Our method involves a fixed-base serial robot moving along a trajectory while sampling data from an end-effector mounted IMU. In this section, models describing how the system's parameters affect measurement outputs are developed in order to facilitate self-calibration of the system.

### A. Serial Robot Model

We adopt the generalized kinematic error method to model the kinematics of serial robots and to parameterize their kinematic errors. An example of this method is disclosed in M. A. Meggiolaro and S. Dubowsky, “An analytical method to eliminate the redundant parameters in robot calibration,” in Proceedings 2000 ICRA. Millennium Conference. IEEE International Conference on Robotics and Automation. Symposia Proceedings (Cat. No. 00CH37065), vol. 4. IEEE, 2000, pp. 3609-3615, the disclosure of which is hereby incorporated by reference in its entirety. We use this method because compared to the Denevit-Hartenburg (DH) error parameterization, it has been shown to be minimal (i.e., no error parameter redundancy), continuous (small changes in error parameters→small changes in robot geometry), and complete (enough parameters to describe any deviation from nominal) (See, for example, R. He, Y. Zhao, S. Yang, and S. Yang, “Kinematic-parameter identification for serial-robot calibration based on poe formula,” IEEE Transactions on Robotics, vol. 26, no. 3, pp. 411-423, 2010, the disclosure of which is hereby incorporated by reference in its entirety.) for any serial robot geometry without any additional modifications. (See, for example, S. Hayati and M. Mirmirani, “Improving the absolute positioning accuracy of robot manipulators,” Journal of Robotic Systems, vol. 2, no. 4, pp. 397-413, 1985, the disclosure of which is hereby incorporated by reference in its entirety. Under this method, each robot link transform is first computed using the standard DH convention

$${T}_{i} = [ \begin{matrix}cos {θ}_{i} & - cos {α}_{i} sin {θ}_{i} & sin {α}_{i} sin {θ}_{i} & {a}_{i} cos {θ}_{i} \\ sin {θ}_{i} & cos {θ}_{i} cos {α}_{i} & - sin {α}_{i} cos {θ}_{i} & {a}_{i} sin {θ}_{i} \\ 0 & sin {α}_{i} & cos {α}_{i} & {d}_{i} \\ 0 & 0 & 0 & 1\end{matrix} ] \qquad Eq . 1$$

where θᵢ, dᵢ, aᵢ, αᵢ are the joint angle offset, the joint offset, link length, and link twist of link i respectively. These DH parameters are the same both before and after calibration.

Rather than using the DH convention to parameterize the kinematic errors, each link transform is modified by 6 generalized error parameters ∈ᵢ_{₁}, ∈ᵢ_{₂}, ∈ᵢ_{₃}, ∈ᵢ_{₄}, ∈ᵢ_{₅}, ∈ᵢ_{₆} where the first three parameters describe translation along the X, Y, and Z axes respectively, and the last three correspond to a YZX Euler rotation sequence. In particular, frame i is modified by the transform

$${E}_{i} = [ \begin{matrix}{c}_{4} {c}_{5} & {s}_{6} {s}_{4} - {c}_{6} {c}_{4} {s}_{5} & {c}_{6} {s}_{4} + {c}_{4} {s}_{6} {s}_{5} & {ϵ}_{{i}_{1}} \\ {s}_{5} & {c}_{6} {c}_{5} & - {c}_{5} {sc}_{6} & {ϵ}_{{i}_{2}} \\ - {c}_{5} {s}_{4} & {c}_{4} {s}_{6} + {c}_{6} {s}_{4} {s}_{5} & {c}_{6} {c}_{4} - {s}_{6} {s}_{4} {s}_{5} & {ϵ}_{{i}_{3}} \\ 0 & 0 & 0 & 1\end{matrix} ] \qquad Eq . 2$$

where for example, c4 stands for cos ∈ᵢ_{₄}, and s6 stands for sin ∈ᵢ_{₆}. Kinematics computation of the rotation and translation (R∈S0(3) and p∈ [symbol] ³ respectively) of the IMU board attached to the robot end effector is carried out by multiplying all of the transforms together in order

$$[ \begin{matrix}R & p \\ {0}^{T} & 1\end{matrix} ] = {E}_{0} {T}_{1} {E}_{1} … {T}_{n} {E}_{n} \qquad Eq . 3$$

where we note that the transform E₀ has been added to describe the pose of the robot base frame relative to a world frame. Additionally, in our setup, Eₙ describes the pose of the IMU frame relative to the end effector.

Given the functions q, \dot{q}, \ddot{q}: [symbol] ␣ [symbol] ⁿ, we can predict the angular velocity ωₙ and linear acceleration aₙ of the IMU frame relative to the robot base using the familiar Newton recurrence relationship

$$\begin{matrix}{ω}_{i + 1} = {ω}_{i} + {n}_{{z}_{i}} {\dot{q}}_{i} ( t ) \\ {α}_{i + 1} = {α}_{i} + {n}_{{z}_{i}} {\ddot{q}}_{i} ( t ) + {ω}_{i} \times ( {n}_{{z}_{i}} {\dot{q}}_{i} ( t ) ) \\ {v}_{i + 1} = {v}_{i} + {ω}_{i + 1} \times {ρ}_{i + 1} \\ {a}_{i + 1} = {a}_{i} + {α}_{i + 1} \times {ρ}_{i + 1} + {ω}_{i + 1} \times ( {ω}_{i + 1} \times {ρ}_{i + 1} )\end{matrix} \qquad Eq . 4$$

where ρᵢ is the distance vector between frame i and frame i−1, and n_{z}_{ᵢ} is the direction of the Z axis of frame i as computed in the DH model in Eq. 3. Note that this calculation also gives the angular acceleration αᵢ and linear velocity vᵢ for each of the robot links. Transforming these quantities from the robot base frame into the IMU frame and adding the force of gravity to the computed acceleration, we get the predicted inertial quantities

$$\begin{matrix}ω ( t ) = {R}^{T} {ω}_{n} \\ s ( t ) = {R}^{T} ( {a}_{n} - g )\end{matrix} \qquad Eq . 5$$

where s and ω are the specific force and angular velocity respectively acting on the sensor and R is the rotation of the IMU frame relative to the robot base computed in Eq. 3. Note that because the magnitude of the gravity vector g is known to be 9.81 m/s², g is parameterized with only two values g_{xy}=[gₓg_{y}]^{T}.

### B. Inertial Sensor Model

The inertial sensor model is used to describe how angular velocity ω and specific force s map to raw voltage values. See, for example, the sensor model disclosed in H. Zhang, Y. Wu, W. Wu, M. Wu, and X. Hu, “Improved multi-position calibration for inertial measurement units,” Measurement Science and Technology, vol. 21, no. 1, p. 015107, 2009, the disclosure of which is hereby incorporated by reference in its entirety. This model accounts for non-unit sensor gains, nonorthogonal sensitivity axes, nonzero sensor voltage biases, and gross sensor rotations relative to the IMU frame. Note that the position of the IMU frame relative to the robot end effector has already been accounted for by Eₙ in Eq. 3.

The model, which relates the inertial quantities ω(t) and s(t) to sensor voltages, is shown below:

$$\begin{matrix}\tilde{ω} ( t ) = {K}_{ω} {Γ}_{ω} {R}_{ω} ω ( t ) + {b}_{ω} \\ \tilde{s} ( t ) = {K}_{a} {Γ}_{a} {R}_{a} s ( t ) + {b}_{a}\end{matrix} where {Γ}_{a} = [ \begin{matrix}1 & 0 & 0 \\ {γ}_{{a}_{yz}} & 1 & 0 \\ - {γ}_{{a}_{zy}} & {γ}_{{a}_{zx}} & 1\end{matrix} ] , {Γ}_{ω} = [ \begin{matrix}1 & 0 & 0 \\ {γ}_{{ω}_{yz}} & 1 & 0 \\ - {γ}_{{ω}_{zy}} & {γ}_{{ω}_{zx}} & 1\end{matrix} ] \\ {K}_{a} = [ \begin{matrix}{k}_{{a}_{x}} 1 & 0 & 0 \\ 0 & {k}_{{a}_{y}} & 0 \\ 0 & 0 & {k}_{{a}_{z}}\end{matrix} ] , {K}_{ω} = [ \begin{matrix}{k}_{{ω}_{x}} 1 & 0 & 0 \\ 0 & {k}_{{ω}_{y}} & 0 \\ 0 & 0 & {k}_{{ω}_{z}}\end{matrix} ] \qquad Eq . 6$$

Here, \tilde{ω} and \tilde{s} are the output voltages caused by the IMU frame's angular velocity ω(t) and specific force s(t) respectively. Note that noise will be added to these ideal outputs \tilde{ω} and \tilde{s} in the full measurement model. The rotation matrix R_{ω} accounts for the gross rotational misalignment of the triaxial gyroscope on the IMU frame and is parameterized by a ZYX Euler angle sequence with parameters (r_{ω}_{_{z}}, r_{ω}_{_{y}}, r_{ω}_{ₓ}). The matrix Rₐ is similar, but is for the accelerometer and has parameters (rₐ_{_{z}}, rₐ_{_{y}}, rₐ_{ₓ}). The lower triangular matrices Γ_{ω} and Γₐ account for small gyroscope and accelerometer sensor axis misalignments to first order. The diagonal matrices K_{ω} and Kₐ are gains which map the physical quantities to voltage values.

Finally, the vectors b_{ω} and bₐ are the triaxial sensor biases (nonzero voltage offsets) for the gyroscope and accelerometer respectively. In this paper, we assume that these parameters are constant. To assess the validity of this assumption with our IMU, a test was performed where we collected IMU data for 25 minutes, 5 times longer than our experiments. To check for drift in the values b_{ω} and bₐ, the IMU data was filtered using a smoothing spline and then computed the error between the spline and the mean. The maximum drift observed was 0.017 m/s2 for the accelerometer and 0.025°/s for the gyroscope.

Both of these values are well within the range of the sensor noise computed below in Section VIII—Planned Trajectory Optimization. This analysis verifies the assumption of constant sensor biases in our specific setup. However, when sensor biases drift significantly, continuous time functions for b_{ω} and bₐ can be neatly folded into the estimation problem.

### C. Parameter Redundancy and Observability

There are currently 6(n+1) generalized error parameters in the robot kinematic model in Eq. 3. However, this is currently not a minimal set of parameters. In other words, there are directions in-space which have no effect on the computed IMU location T in Eq. (3). Several of these redundancies are eliminated prior to calibration, using a known method, such as that disclosed in Meggiolaro and Dubowsky. If ε₀={ε₀_{₁} . . . ε₀_{₆} ε₁_{₁} . . . ε₁_{₆} . . . εₙ_{₁} . . . εₙ_{₆}}∈ [symbol] ⁶⁽ⁿ⁺¹⁾ is the set of all generalized error parameters, the subset ε⊂ε₀ is the minimal set of parameters.

In Meggiolaro and Dubowsky, the authors provide a comprehensive and systematic approach for determining the subset ε depending on whether the end-effector pose measurements include both position and orientation. It is hypothesized (and numerical and real experiments agree) that when considering which parameters to eliminate from ε₀, the 6 IMU measurements can be viewed as equivalent to the 6 pose parameters measured in a standard calibration. Therefore, based on Meggiolaro and Dubowsky, the length of the robot kinematic error vector is at most 6(n+1)−2Nᵣ−4Nₚ, where Nᵣ is the number of revolute joints and Nₚ is the number of prismatic joints.

Furthermore, it is important to note that in the IMU-robot arrangement, the IMU can only provide motion information relative to itself or relative to the robot. This means that the transform from the robot base to the world system E₀ is not observable from the IMU measurements. Because of this, the parameters ε₀_{₁}, ε₀_{₂}, . . . ε₀_{₆} are not included in ε. Finally, the rotation parameters εₙ_{₄}, εₙ₀_{₅}, and εₙ_{₆}, which describe the orientation of the IMU frame are redundant with the each of the sensor orientations Rω and Ra. Therefore, these parameters are eliminated as well. After elimination of these redundant parameters, the length of ε is 6n−2Nᵣ−4Nₚ−3.

Together with the robot parameters ε, 12 gyroscope parameters, 12 accelerometer parameters, 2 gravity direction parameters, and the time offset τ, there are 6n−2Nᵣ−4Nₚ+24 system parameters that we pack into the vector x. Table I details the components of the vector x.

TABLE 1
System Parameter Vector x for the Serial Robot - IMU System

| Symbol | Physical Meaning |
|---|---|
| ε ∈ [symbol] ^{6n-2N}^{ᵣ}^{-4N}^{ₚ}⁻³ | Robot generalized kinematic errors |
| g_{xy} = [gₓg_{y}]^{T} | Direction of the gravity vector |
| τ ∈ [symbol] | Time offset between robot and IMU |
| γₐ = [γₐ_{_{yz}} γₐ_{_{zy}} γₐ_{_{zx}}]^{T} | Accelerometer axis misalignments |
| rₐ = [rₐ_{_{z}} rₐ_{_{y}} rₐ_{ₓ}]^{T} | Accelerometer sensor orientation |
| kₐ = [kₐ_{ₓ} kₐ_{_{y}} kₐ_{_{z}}]^{T} | Accelerometer sensor gains |
| bₐ = [bₐ_{ₓ} bₐ_{_{y}} bₐ_{_{z}}]^{T} | Accelerometer sensor biases |
| γ_{ω} = [γ_{ω}_{_{yz}} γ_{ω}_{_{zy}} γ_{ω}_{_{zx}}]^{T} | Gyroscope axis misalignments |
| r_{ω} = [r_{ω}_{_{z}} r_{ω}_{_{y}} r_{ω}_{ₓ}]^{T} | Gyroscope sensor orientation |
| k_{ω} = [k_{ω}_{ₓ} k_{ω}_{_{y}} k_{ω}_{_{z}}]^{T} | Gyroscope sensor gains |
| b_{ω} = [b_{ω}_{ₓ} b_{ω}_{_{y}} b_{ω}_{_{z}}]^{T} | Gyroscope sensor biases |

It has been previously shown that the transform from an IMU to a tracked object is observable (See, F. M. Mirzaei and S. I. Roumeliotis, “A kalman filter-based algorithm for imu-camera calibration: Observability analysis and performance evaluation,” IEEE Transactions on Robotics, vol. 24, no. 5, pp. 1143-1156, 2008, the disclosure of which is hereby incorporated by reference in its entirety). In this disclosure, many more parameters are added to this problem. As opposed to proving observability in general, in Section VIII, observability of the system parameters x is analyzed numerically for the specific robot setup.

### IV. Bayesian Parameter Estimation

### A. Problem Statement

In our method, instead of taking measurements at static configurations, the IMU is sampled while the robot moves continuously through the trajectory q: [symbol] → [symbol] ⁿ. During robot motion, IMU outputs zᵢ are sampled at times tᵢ and the robot joint transducer outputs qⱼ are sampled at times tⱼ where i=1 . . . N_{z}, j=1 . . . N_{q}, and N_{z}, N_{q} are the number of IMU measurements and the number of joint vector measurements respectively. Note that synchronous measurements of zᵢ and qᵢ are not assumed. The set of all IMU outputs z₁:Nz and the set of all joint vector measurements q₁:N_{q} are then used optimally to infer the system parameters x and the robot trajectory q(t) simultaneously. Here we derive an estimator, for example, roughly following P. Furgale, C. H. Tong, T. D. Barfoot, and G. Sibley, “Continuous time batch trajectory estimation using temporal basis functions,” The International Journal of Robotics Research, vol. 34, no. 14, pp. 1688-1710, 2015, the disclosure of which is hereby incorporated by reference in its entirety.

### B. Posterior Parameter Distribution

All of the information that the measurements z₁:Nz and q₁:N_{q} can reveal about the system parameters x and the robot trajectory q(t) is encoded in the posterior probability distribution p(x, q(t)|q₁:N_{q}, z₁:N_{z}). Bayes' Theorem asserts that this distribution takes the form

$$p ( x , q ( t ) \vert {q}_{1} : {N}_{q} , {z}_{1} : {N}_{z} ) = \frac{p ( {q}_{1} : {N}_{q} , {z}_{1} : {N}_{z} \vert x , q ( t ) ) p ( x , q ( t ) ) )}{p ( {q}_{1} : {N}_{q} , {z}_{1} : {N}_{z} )} \qquad Eq . 7$$

Assuming that the data q₁:N_{q}, z₁:N_{z} and the system parameters x are all statistically independent from the inputs q(t), then the expression on the right becomes:

$$\frac{p ( {q}_{1} : {N}_{q} , {z}_{1} : {N}_{z} \vert x ) p ( x ) p q ( t ) )}{p ( {q}_{1} : {N}_{q} , {z}_{1} : {N}_{z} )} \qquad Eq . 8$$

Additionally assuming that the input measurements q₁:N_{q} are independent of the IMU data z₁:N_{z} leads to:

$$p ( x , q ( t ) \vert {q}_{1} : {N}_{q} , {z}_{1} : {N}_{z} ) = \frac{p ( {q}_{1} : {N}_{q} \vert x ) p ( {z}_{1} : {N}_{z} \vert x ) p ( x ) p ( q ( t ) )}{p ( {q}_{1} : {N}_{q} , {z}_{1} : {N}_{z} )} \qquad Eq . 9$$

### C. Conditional and Prior Distribution Assumptions

In order to make the estimation problem feasible, we must make statistical assumptions about the distributions of the measured data. As is often done, we assume a zero-mean, Gaussian measurement model for both the joint vector samples and the IMU outputs:

$$\begin{matrix}{q}_{j} = q ( {t}_{j} ) + {n}_{j , q} , & {n}_{q , j} ∼ 𝒩 ( 0 , {\sum }_{{q}_{j}} ) \\ {z}_{i} = h ( {t}_{i} + r , x ) + {n}_{z , i} , & {n}_{z , i} ∼ 𝒩 ( 0 , {\sum }_{{z}_{i}} )\end{matrix} \qquad Eq . 10$$

where n_{g,j} and n_{z,i} are zero-mean Gaussian random vectors with covariance Σ_{q}_{ⱼ} and Σ_{z}_{ᵢ}. Here, the function h: ( [symbol] × [symbol] ^{6n-2r-4p+24}) [symbol] [symbol] ⁶ stacks the vectors \tilde{s}(t) and \tilde{ω}(t) and is dependent on the function q(t). Equation (10) implies that the conditional distributions of the data are:

$$p ( {q}_{j} \vert x ) ∼ 𝒩 ( q ( {t}_{j} ) , {\sum }_{{q}_{j}} ) \\ p ( {z}_{i} \vert x ) ∼ 𝒩 ( h ( {t}_{i} + τ , x ) , {\sum }_{{z}_{i}} ) \qquad Eq . 11$$

We also assume that the prior distribution of the system parameters are independent and Gaussian:

$$p ( x ) ∼ 𝒩 ( \hat{x} , {\sum }_{\hat{x}} ) \qquad Eq . 12$$

where \hat{x} are the nominal parameters and Σ_{\hat{x}} is the assumed covariance of the nominal parameters (e.g. from known measurement or manufacturing error).

The final assumption is that the prior distribution of the joint value function p(q)(t)) over the joint space is constant and uniform for all time. In other words, we assume that there is no prior information about the robot trajectory. Given these assumptions, the posterior distribution (Eq. 9) is proportional to a product of Gaussians where the constant of proportionality does not depend on either x or q(t) In particular, the proportionality can be expressed as:

$$p ( x , q ( t ) \vert {q}_{1} : {N}_{q} , {z}_{1} : {N}_{z} ) ∝ p ( x ) {\prod }_{j = 1}^{{N}_{q}} p ( {q}_{j} \vert x ) {\prod }_{i = 1}^{{N}_{z}} p ( {z}_{i} \vert x ) \qquad Eq . 13$$

### D. Maximum A Posteriori Formulation

The maximum a posteriori estimate seeks to minimize the negative logarithm of the posterior distribution, as this is equivalent to maximization of the distribution:

$$( {x}^{*} , {q}^{*} ( t ) ) = {arg min}_{x , q ( t )} \{ - log ( p ( x , q ( t ) \vert {q}_{1} : {N}_{q} , {z}_{1} : {N}_{z} ) ) \} \qquad Eq . 14$$

Given the Gaussian assumptions, Eq. 13 shows that the objective function in Eq. 14 can be expanded into the following quadratic form in the unknowns x and q(t):

$$log ( p ( x , q ( t ) \vert {q}_{1 : N} , {z}_{1 : N} ) ) = c + {J}_{q} + {J}_{z} + {J}_{x} \qquad Eq . 15$$

where c is some constant that does not depend on the system parameters x or the joint vector function q(t) and:

$${J}_{q} = \frac{1}{2} {\sum }_{i = 1}^{{N}_{q}} {e}_{x}^{T} {Σ}_{{Z}_{i}}^{- 1} {e}_{{z}_{i}} \qquad Eq . 16$$

$${e}_{{q}_{j}} = {q}_{j} - q ( {t}_{j} )$$

$${J}_{z} = \frac{1}{2} {\sum }_{i = 1}^{N} {e}_{x}^{T} {Σ}_{{Z}_{i}}^{- 1} {e}_{{z}_{i}}$$

$${e}_{{z}_{i}} = {z}_{i} - h ( {t}_{i} + r , x )$$

$${J}_{x} = {e}_{x}^{T} {Σ}_{{Z}_{i}}^{- 1} {e}_{{z}_{i}}$$

$${e}_{x} = x - x$$

Defining J(x, q(t))=J_{q}+J_{z}+Jₓ, and because the constant c does not depend on the optimization variables, the solution to

$$( {x}^{*} , {q}^{*} ( t ) ) = {arg min}_{x , q ( t )} \{ J ( x , q ( t ) ) \} \qquad Eq . 17$$

is the same as the MAP estimate (Eq. 14). Therefore, solving the optimization problem (Eq. 17) leads to the MAP estimate of the system parameters x and the trajectory q(t).

### V. Trajectory Representation

Currently, along with the parameter vector x, one of the unknowns in the optimization problem of Eq. 17 is a function q(t). To compute a solution requires a representation of q(t) that a computer can evaluate. Usually, continuous functions are approximated as a sum of basis functions, but the particular basis functions used are a design choice. For example, the basis functions disclosed in either of the following, both of which are hereby incorporated by reference in their entireties, can be used:
P. Furgale, C. H. Tong, T. D. Barfoot, and G. Sibley, “Continuous time batch trajectory estimation using temporal basis functions,” The International Journal of Robotics Research, vol. 34, no. 14, pp. 1688-1710, 2015.
P. Furgale, J. Rehder, and R. Siegwart, “Unified temporal and spatial calibration for multi-sensor systems,” in 2013 IEEE/RSJ International Conference on Intelligent Robots and Systems. IEEE, 2013, pp. 1280-1286.

In doing so, B-splines are chosen as a basis to represent the unknown function q(t). There are two main advantages to this choice of basis for continuous-time batch estimation. One is that B-splines are locally supported. In other words, the contribution of any single basis function is local in time. This is useful for solving problems like Eq. 17 because the changes in the state trajectory caused by a change in a B-spline coefficient are zero almost everywhere. This makes for a sparse Jacobian and thus efficient nonlinear least squares solutions. Second, there are simple and efficient algorithms for evaluating B-spline functions, derivatives, and integrals—quantities that are necessary for evaluation of the objective function of Eq. 17. For example, the algorithms disclosed in such as L. L. Schumaker, Spline functions: computational methods. SIAM, 2015, the disclosure of which is hereby incorporated by reference in its entirety, can be used for evaluation of the objective function of Eq. 17.

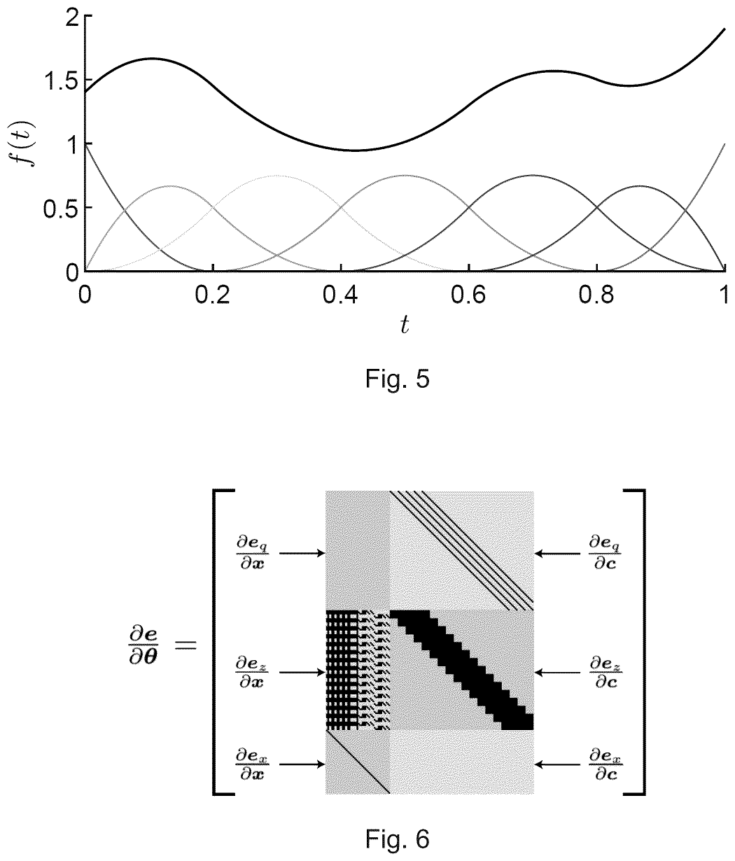

The robot trajectory q(t) is represented as linear combinations of B-splines following the general methodology of Schumaker. Given spline degree d, smoothness d−1, and time points a=x₀<x₁ . . . <xₖ<xₖ₊₁=b in an interval Ω=[a, b], the extended partition Δₑ={yᵢ}ᵢ₌₁^{n+d+1} is defined to be:

$$\begin{matrix}a = {y}_{1} = ⋯ = {y}_{d + 1} , \\ {y}_{n + 1} = ⋯ = {y}_{n + d + 1} = b , \\ {y}_{d + 2} \leq ⋯ \leq {y}_{n} = {x}_{1} , ⋯ {x}_{k} ,\end{matrix} \qquad Eq . 18$$

where the dimension of the spline space can be shown to be m=k+d+1. Given this extended partition Δₑ, in one dimension, functions are represented as linear combinations of the normalized B-splines:

$$f ( t ) = {\sum }_{i = 1}^{m} {c}_{i} {N}_{i}^{d + 1} ( t ) \qquad Eq . 19$$

where ƒ is any function in the spline space, the Nᵢ^{d+1}(t) are the normalized B-splines of order d+1 and the cᵢ are the multiplying coefficients which determine the shape of the function ƒ(t). An example function is shown in FIG. 5.

FIG. 5 is a representation of a B-Spline function. The normalized B-splines {Nᵢ³(t)}ᵢ₌₁⁷ are shown in color. The function ƒ(t) which is a linear combination (c=[1.4 1.9 1.0 0.9 1.7 1.3 1.9]^{T}) of the B-splines is shown in black. The B-splines make for efficient function evaluation and differentiation, and their local support makes for efficient solving of continuous-time trajectory estimation problems.

Extending this representation to n dimensions, we can write curves such as the robot trajectory in Eq. 17 using the following matrix equation:

$$q ( t ) = {CN}^{d + 1} ( t ) = [ \begin{matrix}{c}_{11} & {c}_{12} & ⋯ & {c}_{1 m} \\ {c}_{21} & {c}_{22} & & ⋮ \\ ⋮ & & ⋱ & ⋮ \\ {c}_{n 1} & ⋯ & ⋯ & {c}_{nm}\end{matrix} ] [ \begin{matrix}{N}_{1}^{d + 1} ( t ) \\ ⋮ {N}_{2}^{d + 1} ( t ) \\ ⋮ \\ {N}_{m}^{d + 1} ( t )\end{matrix} ] \qquad Eq . 20$$

As the basis functions are known, if the matrix C is known, then one way to calculate q(t) is by evaluating all of the B-splines that have value at the time point and then computing the linear combinations using Eq. 20.

However, a more efficient way to evaluate Eq. 20 is to use the recurrence relationship outlined in Schumaker. Additionally, we use a similar relationship (also outlined in Schumaker) to compute the B-spline coefficients corresponding to the derivatives of Eq. 20, \dot{q}(t) and \ddot{q}(t), from the matrix C.

Finally, as mentioned earlier, one important advantage of the B-spline representation is its local support. More specifically, when considering the interval Ωᵢ=[yᵢ, y_{yi+d+1i}],

$$\begin{matrix}{N}_{i}^{d + 1} ( t ) > 0 for {y}_{i} < t < {y}_{i + d + 1} \\ {N}_{i}^{d + 1} ( t ) = 0 otherwise .\end{matrix} \qquad Eq . 21$$

This is illustrated in FIG. 5, where each of the basis functions only take on nonzero values within a smaller subset of the total interval [0,1]. This fact is exploited in Section VII where optimal trajectories are iteratively generated to maximize observability.

### VI. Least Squares Formulation

Our ultimate goal is to solve Eq. 17, determining estimates for the parameters x as well as the unknown actual trajectory q(t). However, in light of the chosen trajectory representation of Eq. 20, the new unknowns to be estimated are x and C. Writing the coefficient matrix C as a vector:

$$c = {[ {c}_{11} ⋯ {c}_{n 1} ⋯ {c}_{1 m} ⋯ {c}_{nm} ]}^{T} ,$$

and defining the full vector of unknowns Θ=[x^{T} c^{T}]^{T}, the cost function in Eq. 17 can be rewritten in matrix form as:

$$J ( Θ ) = \frac{1}{2} {e}^{T} {Σ}_{e}^{- 1} e \qquad Eq . 22$$

$$where$$

$$\begin{matrix}e = {[ {e}_{q 1}^{T} ⋯ {e}_{qN}^{T} {e}_{z 1}^{T} ⋯ {e}_{zN}^{T} {e}_{x} ]}^{T} \\ {Σ}_{e} = [ {Σ}_{q 1} {⋯Σ}_{{qN}_{j}} {Σ}_{z 1} {⋯Σ}_{{zN}_{i}} {Σ}_{x} ]\end{matrix}$$

The residual vector of Eq. 22 can be written as:

$$δ = Le \qquad Eq . 23$$

where L is the Cholesky factor of Σₑ⁻¹(Σₑ⁻¹=L^{T}L). Note that the Cholesky decomposition always exists in the case of symmetric, positive definite matrices like Σₑ⁻¹.

If a unique solution exists, this problem can be solved with any nonlinear least squares solver such as the Levenberg-Marquardt (LM) algorithm. Furthermore if the solution is nearby to the nominal solution, the confidence in our estimate Θ* is encoded in the posterior covariance matrix:

$${Σ}_{Θ} = {( {[ \frac{\partial e}{\partial Θ} ]}^{T} {Σ}_{e}^{- 1} \frac{\partial e}{\partial Θ} )}^{- 1} \qquad Eq . 24$$

where

$$\frac{\partial e}{\partial Θ}$$

is the identification Jacobian matrix associated with Θ. Note that least squares solvers like the LM algorithm generally benefit from providing a derivative to Eq. 23. In this case, assuming that L is constant, differentiation of Eq. 23 results in:

$$\frac{\partial δ}{\partial Θ} = L \frac{\partial e}{\partial Θ} \qquad Eq . 25$$

### A. The Structure of the Jacobian

$$\frac{\partial e}{\partial Θ}$$

In our experiments, solution of Eq. 22 was not feasible with standard, dense matrices. Here, we analyze the sparsity structure of

$$\frac{\partial e}{\partial Θ}$$

determining which elements of the Jacobian are nonzero. Knowledge of this structure enables the use of sparse finite difference methods to compute

$$\frac{\partial e}{\partial Θ}$$

making solution of Eq. 22 feasible.

First, we note that of the parameters Θ=[x^{T} c^{T}]^{T}, the system parameters x only influence the output measurement errors e_{z} and cannot influence the input measurement errors e_{q}. Inspection of Eq. 16 verifies this; e_{q} is only a function of c, so

$$\frac{\partial {e}_{q}}{{\partial }_{x}} = 0 .$$

In contrast, each component of the spline coefficients c can affect both e_{q} and e_{z}. However, the local support of B-splines (Eq. 21) makes many of the elements of

$$\frac{\partial {e}_{q}}{{\partial }_{c}} and \frac{\partial {e}_{z}}{{\partial }_{c}}$$

zero. For measurements qᵢ taken at time

tᵢ∉[yⱼ, y_{j+d+1}], the derivative of Eq. 21 is zero. Employing the chain rule on e_{qi} in Eq. 16 shows that

$$\frac{{\partial }_{{e}_{{q}_{i}}}}{{\partial }_{{c}_{j}}} = 0 .$$

Similarly, the effect of cⱼ is local on e_{z}. A similar argument shows that for measurements zᵢzi taken at time (tᵢ+τ)∉[yⱼ, y_{j+d+1}],

$$\frac{\partial {e}_{z}}{{\partial }_{c}} = 0 .$$

Finally, a spline coefficient can only affect e_{qi} if it is on the same row in the matrix of Eq. 20, so

$$\frac{{\partial }_{{e}_{{q}_{i}}}}{{\partial }_{{c}_{j}}}$$

can have only one nonzero element.

Next we note that the parameters in e which correspond to translational displacements cannot affect the orientation of the end effector. Therefore, the model predicted rate of orientation ω also cannot be affected by such length parameters, so that

$$\frac{\partial {e}_{ω}}{\partial {ϵ}_{i}} = 0$$

when i∈{1,2,3}. As the gravity direction also does not affect measured orientations,

$$\frac{\partial {e}_{ω}}{\partial {g}_{x y}} = 0 .$$

Because of the way the sensor misalignments γₐ and γ_{ω} are incorporated into the matrices Γₐ and Γ_{ω} (Eq. 6), the corresponding matrices

$$\frac{\partial {e}_{ω}}{\partial {γ}_{ω}} and \frac{\partial {e}_{α}}{\partial {γ}_{α}}$$

have sparsity structures:

$$[ \begin{matrix}0 & 0 & 0 \\ * & 0 & 0 \\ 0 & * & *\end{matrix} ]$$

where a * indicates any nonzero element. Similarly, it can be shown that the YZX Euler sequences rₐ and r_{ω}r! lead to the sparsity structure:

$$[ \begin{matrix}* & * & 0 \\ * & 0 & * \\ 0 & * & *\end{matrix} ]$$

for the matrices

$$\frac{\partial {e}_{ω}}{\partial {r}_{ω}} and \frac{\partial {e}_{α}}{\partial {r}_{α}} .$$

As the gain matrices Kₐ and K_{ω} are diagonal, and the sensor biases are just offsets,

$$\frac{\partial {e}_{ω}}{\partial {k}_{ω}} , \frac{\partial {e}_{α}}{\partial {k}_{α}} , \frac{\partial {e}_{ω}}{\partial {b}_{ω}} , and \frac{\partial {e}_{α}}{\partial {b}_{α}}$$

are all diagonal, 3×3 matrices. Finally, we note that the accelerometer parameters cannot affect the gyroscope outputs, and similarly, the gyroscope parameters cannot affect the accelerometer outputs; therefore, the following matrices are zero:

$$\frac{\partial {e}_{ω}}{\partial {γ}_{a}} , \frac{\partial {e}_{ω}}{\partial {r}_{a}} , \frac{\partial {e}_{ω}}{\partial {k}_{a}} , \frac{\partial {e}_{ω}}{\partial {b}_{a}} , \frac{\partial {e}_{a}}{\partial {γ}_{ω}} , \frac{\partial {e}_{a}}{\partial {r}_{ω}} , \frac{\partial {e}_{a}}{\partial {k}_{ω}} , and \frac{\partial {e}_{a}}{\partial {b}_{ω}} .$$

For eₓ,

$$\frac{\partial {e}_{x}}{\partial c}$$

is an identity matrix of size 6n−2r−4p+24 and

$$\frac{\partial {e}_{χ}}{\partial x}$$

is a zero matrix with size (6n−2r−4p+24)×nm. A diagram showing an example sparsity structure of the full Jacobian

$$\frac{\partial e}{\partial x}$$

can be seen in FIG. 6. This diagram was generated using the system in experiments with 15 measurements of both q and z for visualization purposes. Note that with only 15 measurements,

$$\frac{\partial e}{\partial x}$$

in FIG. 6 is only about 85% sparse, but it was greater than 99% sparse in experiments where many thousands of measurements were taken.

FIG. 6. Sparsity pattern of the Jacobian matrix

$$\frac{\partial e}{\partial x}$$

which can be exploited for efficient least squares solutions. The labeled, grey submatrices combine to form the full block matrix

$$\frac{\partial e}{\partial x} .$$

Black pixels indicate elements that are not necessarily zero, and grey pixels indicate entries that are always zero. In this example, only Nᵢ=Nⱼ=15 data samples are used, for visualization purposes. In experiments, however, over 30000 samples were used, leading to a Jacobian with greater than 99% sparsity.

### VII. Planned Trajectory Optimization

Even though part of the problem is to estimate the actual robot trajectory q, up to this point, the commanded robot trajectory \tilde{q}: [symbol] [symbol] [symbol] ⁿ is still arbitrary. The actual robot trajectory q will in general differ from the plan \tilde{q} by some amount due to robot controller errors. While the joint values could be commanded to follow any trajectory (such as a sine wave), numerical experiments show that estimation error can be reduced substantially by commanding a trajectory \tilde{q} that is in some sense optimal.

Optimal trajectory determination has been used for identification of robot dynamic parameters for many years. (See, for example, J. Swevers, C. Ganseman, D. B. Tukel, J. De Schutter, and H. Van Brussel, “Optimal robot excitation and identification,” IEEE transactions on robotics and automation, vol. 13, no. 5, pp. 730-740, 1997, or V. Bonnet, P. Fraisse, A. Crosnier, M. Gautier, A. Gonzalez, and G. Venture, “Optimal exciting dance for identifying inertial parameters of an anthropomorphic structure,” IEEE Transactions on Robotics, vol. 32, no. 4, pp. 823-836, 2016). According to the present disclosure, however, a new method is used, which specifically deals with long trajectories, such as the 5 minute timescale in the self-calibration problem. Instead of solving for the trajectory in a single step, the plan \tilde{q} is split up into many intervals. The information provided by all previous intervals is used to solve for the next segment of \tilde{q} within the current interval. This method is enabled by the local support of B-splines; as the effects of B-spline coefficients are local in time, changes in \tilde{q} within an interval can be achieved by altering only a few elements of c enabling sequential solutions.

### A. Efficient Approximation of Σₓ

In order to generate an optimal trajectory plan \tilde{q}, what is meant mean by “optimal” needs to be defined. The ultimate goal is to estimate the parameter vector x, so our definition for optimality should ultimately serve to reduce the posterior estimation error Σₓ.

In order to develop an efficient approximation for Σₓ, it is momentarily assumed that the actual robot trajectory q is sufficiently close to the planned trajectory \tilde{q} (i.e. that the actual trajectory is known, \tilde{q}=q). This assumption is reasonable because robot controllers are generally accurate at following planned trajectories. Furthermore, numerical results show that, even with this assumption, the parameter estimates are about 10 times more precise than if random trajectories are used. Note that the validity of this approximation is verified in the numerical experiments (See, Section VIII). The temporary assumption that q is not random (\tilde{q}=q) enables efficient approximation of Σₓ. When given a trajectory plan \tilde{q}; the posterior covariance of x takes the form

$${\sum }_{x} = {( {\sum }_{\hat{x}}^{- 1} + {[ \frac{\partial {e}_{z}}{\partial x} ]}^{T} {\sum }_{\hat{z}}^{- 1} \frac{\partial {e}_{z}}{\partial x} )}^{- 1} \qquad Eq . 26$$

where E_{z}=blkdiag[Σ_{z}_{₁} . . . Σ_{z}_{_{N}}] and e_{z}=[e_{z}_{₁}^{T} . . . e_{z}_{_{N}}^{T}]^{T}.

Approximation of Σₓ using (26) is significantly more efficient than computing Σ₀ with Eq. 24 and then extracting Σₓ. In the former case, we only need to compute a Jacobian

$$\frac{\partial {e}_{z}}{\partial x}$$

of size 6Nᵢ×48 (assuming a 6-axis rotary system). In the latter case, we would have to compute the matrix @e @✓ of size (6Nⱼ+6Nᵢ+48)×(48+6m). Because Nⱼ and m are generally quite large (e.g. 36000 and 303 in the experiments), the matrix

$$\frac{\partial e}{\partial θ}$$

is much larger in both dimensions than

$$\frac{\partial {e}_{z}}{\partial x} .$$

Therefore, as long as the approximation of Eq. 26 is reasonably accurate, a significant efficiency advantage can be had by using Eq. 26 over Eq. 24 for the many thousands of computations of Σₓ during trajectory optimization. The accuracy of Eq. 26 was validated with numerical experiments. The following paragraphs discuss using Eq. 26 to generate optimal trajectory plans \tilde{q}.

### B. Trajectory Optimization Problem Statement

First, the posterior parameter uncertainty Σₓ depends on the planned trajectory \tilde{q} to some extent as a stationary trajectory would not excite the system at all. To reduce posterior uncertainty, we want to make Σₓ as small as possible in some sense by varying the B-spline coefficients c (and thus q(t)). This will make it so that after solving (22), the estimate of the parameter vector x will be as precise as possible given the potential constraints on q(t).

It is well-known that the maximum singular value of Σₓ provides an upper bound on the posterior variance of any parameter in x. To reduce parameter uncertainty, we minimize the maximum singular value of Σₓ. In particular, to generate trajectories that maximize the observability of x, we solve the following optimization problem:

$${c}^{*} = {arg min}_{c} \{ max svd ( {\sum }_{x} ) \} \qquad Eq . 27$$

$$subject to :$$

$${q}_{min} \leq [ \begin{matrix}q ( t ) \\ \dot{q} ( t ) \\ \ddot{q} ( t )\end{matrix} ] \leq {q}_{max} for all t \qquad Eq . 28$$

where the vectors qₘᵢₙ and qₘₐₓ constrain the trajectory by setting upper and lower bounds on the joint values, velocities, and accelerations.

Solving Eq. 27 using the approximation of Eq. 26 should ensure a safe and (approximately) optimal trajectory during data collection. However, in order to achieve good results, the data collection process must proceed over several minutes. In experiments, this long trajectory corresponds to a c with length 1818. With an objective function (Eq. 27) taking several seconds to compute, a solution of this large scale, inequality constrained, nonlinear optimization problem is not feasible on a typical PC platform. Therefore, the method splits the problem up into many smaller optimization problems that can be solved sequentially.

### C. Sequential Trajectory Optimization

To solve this large problem in many smaller sequential steps, we first partition the trajectory domain into many smaller intervals. The local support of B-splines makes it so that the trajectory in each interval is only affected by a small subset of the variable coefficients c. This fact is exploited to derive an efficient, sequential trajectory optimization scheme that could in principle be used for any system identification problem.

Toward partitioning the time domain, we first split the matrix C into several blocks C=[C0 C1 C2 . . . C_{N}_{ₛ} C_{N}_{ₛ}+1] where Ns=[n/N_{c}] and N_{c} is the number of columns in each of the blocks and is arbitrary. The matrix C is padded on the right and left with C₀=C_{N}_{ₛ₊₁}=C_{pad}∈ [symbol] ^{n×d} in which all of the columns are constant and equal; this serves to make the beginning and end of the trajectory have zero derivative values so that it is smooth. The rows of C are all initialized to be the mean values of the joint limits so that the nominal trajectory is centered at the middle of the joint space with no motion. During each iteration (j=1, . . . , Nₛ), our algorithm will update the next N_{c} columns of C, (i.e., the matrix Cⱼ) given knowledge of all previously computed columns C0, C1, . . . , Cⱼ₋₁.

Because of B-splines' local support (Eq. 21), the columns Cⱼ only have effect on the interval Ω₀_{ⱼ}=[y_{d+1+N}_{_{c}}₍ⱼ₋₁₎, y_{2(d+1)+N}_{_{c}}_{(j-1)+N}_{_{c}}]. We could consider the information about x that sampling on this interval would yield. However, some of the affect of Cⱼ overlaps into the interval affected by Cⱼ₊₁ which is not desirable for solving for the trajectory sequentially. Therefore, we associate with Cⱼ the interval Ω₀_{ⱼ} excluding the next interval Ω₀_{ⱼ}₊₁. Specifically, the interval that we associate with Cⱼ is:

$${Ω}_{j} = {Ω}_{{0}_{j}} - {Ω}_{{0}_{j}} ⋂ {Ω}_{{0}_{j + 1}} = [ {y}_{d + 1 + {N}_{c} ( j - 1 )} , {y}_{d + 1 + {N}_{cj}} ] \qquad Eq . 29$$

Using the general results for recursively processing sets of measurements for estimation (see, e.g., P. S. Maybeck, Stochastic models, estimation, and control. Academic press, 1982, the disclosure of which is hereby incorporated by reference in its entirety), Eq. 26 can be decomposed into:

$${\sum }_{x} = {( {\sum }_{\hat{x}}^{- 1} + {\sum }_{0}^{- 1} + {\sum }_{1}^{- 1} + … + {\sum }_{{N}_{s}}^{- 1} + {\sum }_{{N}_{s + 1}}^{- 1} )}^{- 1} \qquad Eq . 30$$

where the covariance of x associated with interval Ωⱼ is:

$${\sum }_{j} = {( [ \frac{\partial {e}_{{z}_{j}}}{\partial x} ] {\sum }_{{z}_{j}}^{- 1} \frac{\partial {e}_{{z}_{j}}}{\partial x} )}^{- 1} \qquad Eq . 31$$

Here, e_{z}_{ⱼ} is the vector obtained by stacking all of the e_{z}_{ᵢ} that happen to fall in the interval Ωⱼ; Σ_{zj} are all of the associated covariance matrices. The covariances Σⱼ in Eq. 31 can be interpreted as the uncertainty of the parameters x, given only the data sampled within the interval Ωⱼ. In Eq. 30, all of these intervals are brought together with the prior covariance Σ_{\hat{x}} to compute the posterior covariance Σₓ.

Next, we note that we can truncate the sum in Eq. 30 after only a portion of the Nₛ intervals have occurred. This suggests the following recurrence relationship to compute the posterior covariance of x after j time intervals have occurred:

$${\sum }_{{x}_{j}} = {( {\sum }_{{x}_{j - 1}}^{- 1} + {\sum }_{j}^{- 1} )}^{- 1} \qquad Eq . 32$$

where Σₓⱼ is the posterior covariance of x given measurements in all intervals up to and including Ωⱼ. The trajectory q(t) (and thus the data sampled) in Ωⱼ is only dependent on the coefficients Cⱼ due to the locality of B-splines. Thus, the covariance Σⱼ is only a function of Cⱼ, a small subset of the full parameter matrix C. Further, the construction of Σⱼ ensures that Cⱼ will have no effect on the prior covariance Eₓ_{ⱼ₋₁} which (given all Cₖ where 1≤k<j) has already been established in the previous iteration.

Therefore, instead of solving the optimization problem of Eq. 27 all at once, during each of the Nₛ iterations, we instead solve the following local problem:

$${C}_{j}^{*} = {arg min}_{{C}_{j}} \{ max svd ( {\sum }_{{x}_{j}} ) \} \qquad Eq . 33$$

subject to the same trajectory constraints (Eq. 28) as the global problem. Solving Eq. 33 for j=1 . . . Nₛ will give all of the columns of the full matrix C which should approximately solve Eq. 27.

During each iteration, this process can be thought of as adding onto the trajectory some new small trajectory piece over the added interval Ωⱼ. This additional trajectory piece only affects Σⱼ in the sum in (32). By changing Cⱼ, we design the information Σⱼ in this new interval to optimally combine with the prior, known information Eₓ_{ⱼ₋₁} from the previous iterations. Note that the B-spline function representation ensures that the function q(t) maintains continuity over its entire domain throughout this process.

This sequential approach may not lead to exactly the same solutions as directly solving Eq. 27. It is, however, significantly more efficient. Furthermore, in numerical experiments, trajectories generated in this way achieve parameter estimates that are 10 times more precise than using a random trajectory. Finally, because the approach essentially adds to the full trajectory a new small piece, it can be terminated once the covariance Σₓ becomes sufficiently small which makes the method more flexible than solving Eq. 27 directly.

### VIII. Numerical Experiments

A. Nominal System Parameters and Prior Uncertainties All of our numerical and real experiments are conducted with an AUBO i5 collaborative industrial arm (AUBO Robotics, USA) with an end effector-mounted Bosch BNO055 9-axis orientation sensor (see FIG. 12). Note that while this IMU is capable of estimating some of its parameters online, throughout our experiments, we are using it in the raw output mode collecting only raw triaxial accelerometer and gyroscope outputs. Note that while these outputs are generally voltages, our IMU instead outputs in inertial units converting using hardcoded gain values internally. While this does affect the units of our identified and nominal parameters (e.g. unitless sensor gains, biases with non-voltage units), it does not affect our method, as these parameters can be formed into an equivalent model. Here we justify all of the nominal parameters (and their prior uncertainties) related to our numerical and real experiments. A summary of this information is shown in Table II.

By definition, the nominal values for all of the robot kinematic errors e are zero, and as machining errors are generally on the order or 0.1 mm, we conservatively choose prior STDs of 1.0 mm for length parameters and 1.0! for angle parameters. Nominally, the gravity direction parameters gₓ and g_{y} are zero as gravity should only be acting in the Z axis, but if the robot is mounted on the table with some angle θ₀, then the largest that either could be is 9.81 sin θ₀. A conservative value for θ₀ is 5°, which implies a prior STD for gₓ and g_{y} of about 0.5 m/s². As we have no prior information about the time offset τ, its nominal value is zero, and we conservatively choose a large prior STD of 1 second. The IMU board was oriented carefully onto the end effector at the nominal orientation for rₐ and r_{ω}. However, to account for potential mounting and machining errors, we choose prior STDs of 5° for the sensor orientations. The position of the IMU board relative to the end effector was measured with a set of calipers. To account for measurement error here, a prior STD of 10 mm was chosen for the parameters ∈₆_{₁}, ε₆_{₂}, ∈₆_{₃}.

The nominal values and prior uncertainties for the sensor parameters were chosen based on the IMU data sheet. For the triaxial accelerometer, the maximum cross axis sensitivity was quoted as 2%. This means that the maximum misalignment angle is sin⁻¹(0.02)=1.146°, so we choose prior STDs of 1.5° for γₐ to be conservative. The maximum deviation of the accelerometer sensitivity was quoted as 4%. Therefore, we conservatively choose prior STDs of 0.1 for kₐ. The maximum zero-g offset was 150 mg=1.4715 m/s², so conservative prior STDs of 2.0 m/s² were chosen for bₐ. The gyroscope cross axis sensitivity was quoted as 3%. Therefore, as sin⁻¹(0.03)=1.7191°, we choose prior STDs of 2° for γ_{ω}. The maximum deviation of the sensitivity was quoted to be 3%. Therefore, prior STDs of 0.1 for k_{ω} were chosen. The maximum zero-rate offset was quoted as 3°/s. Given this, prior STDs of 5°/s for b_{ω} were chosen.

The standard assumption adopted throughout the experiments was that the parameters x are not initially correlated. Therefore, the initial covariance of the parameters Σ_{\hat{x}} is diagonal; the elements on the diagonal of Σ_{\hat{x}} are then the squares of the initial standard deviations in Table 2.

TABLE 2
Nominal and Calibrated Model Parameters x and
their Standard Deviations in Experiments

| | | Nominal | Nominal | Calibrated | Standard |
|---|---|---|---|---|---|
| Parameter | Units | Value | STD | Value | Calibration |
| ϵ₁_{₁} | mm | 0.0 | 1.0 | — | * |
| ϵ₁_{₆} | ° | 0.0 | 1.0 | 0.0692 | −0.212 |
| ϵ₂_{₁} | mm | 0.0 | 1.0 | — | * |
| ϵ₂_{₂} | mm | 0.0 | 1.0 | — | * |
| ϵ₂_{₄} | ° | 0.0 | 1.0 | 0.0819 | 0.0870 |
| ϵ₂_{₆} | ° | 0.0 | 1.0 | 0.2144 | 0.1269 |
| ϵ₃_{₁} | mm | 0.0 | 1.0 | — | * |
| ϵ₃_{₂} | mm | 0.0 | 1.0 | — | * |
| ϵ₃_{₄} | ° | 0.0 | 1.0 | 0.0421 | 0.0579 |
| ϵ₃_{₆} | ° | 0.0 | 1.0 | 0.1534 | 0.2182 |
| ϵ₄_{₁} | mm | 0.0 | 1.0 | — | * |
| ϵ₄_{₂} | mm | 0.0 | 1.0 | — | * |
| ϵ₄_{₄} | ° | 0.0 | 1.0 | −0.0070 | 0.0117 |
| ϵ₄_{₆} | ° | 0.0 | 1.0 | 0.0258 | −0.0075 |
| ϵ₅_{₁} | mm | 0.0 | 1.0 | — | * |
| ϵ₅_{₂} | mm | 0.0 | 1.0 | — | * |
| ϵ₅_{₄} | ° | 0.0 | 1.0 | 0.3795 | 0.3870 |
| ϵ₅_{₆} | ° | 0.0 | 1.0 | −0.0751 | −0.0171 |
| ϵ₆_{₁} | mm | 25.2 | 10.0 | 28.0233 | * |
| ϵ₆_{₂} | mm | 78.3 | 10.0 | 73.7862 | * |
| ϵ₆_{₃} | mm | 18.2 | 10.0 | 16.8530 | * |
| gₓ | m/s² | 0.0 | 0.5 | 0.0506 | * |
| g_{y} | m/s² | 0.0 | 0.5 | −0.0405 | * |
| τ | S | 0.0 | 1.0 | −0.0806 | * |
| γₐ_{_{yz}} | ° | 0.0 | 1.5 | 0.7217 | 0.7401 |
| γₐ_{_{zy}} | ° | 0.0 | 1.5 | 1.7363 | 1.18197 |
| γₐ_{_{zx}} | ° | 0.0 | 1.5 | −0.0196 | −0.0051 |
| rₐ_{_{z}} | ° | 180.0 | 5.0 | 180.2329 | * |
| rₐ_{_{y}} | ° | 0.0 | 5.0 | 2.0984 | * |
| rₐ_{ₓ} | ° | 0.0 | 5.0 | 1.0842 | * |
| kₐ_{ₓ} | none | 0.0 | 0.1 | 0.9933 | 0.9933 |
| kₐ_{_{y}} | none | 0.0 | 0.1 | 0.9768 | 0.9768 |
| kₐ_{_{z}} | none | 0.0 | 0.1 | 0.9824 | 0.9810 |
| bₐ_{ₓ} | m/s² | 0.0 | 2.0 | −0.1234 | −0.1209 |
| bₐ_{_{y}} | m/s² | 0.0 | 2.0 | 0.300 | 0.2741 |
| bₐ_{_{z}} | m/s² | 0.0 | 2.0 | −0.1452 | −0.1397 |
| γ_{ω}_{_{yz}} | ° | 0.0 | 2.0 | 0.0461 | 0.0187 |
| γ_{ω}_{_{zy}} | ° | 0.0 | 2.0 | −0.1581 | −0.1236 |
| γ_{ω}_{_{zx}} | ° | 0.0 | 2.0 | −0.0916 | −0.0280 |
| r_{ω}_{_{z}} | ° | 180.0 | 5.0 | 181.2498 | * |
| r_{ω}_{_{y}} | ° | 0.0 | 5.0 | 1.6536 | * |
| r_{ω}_{ₓ} | ° | 0.0 | 5.0 | 0.8570 | * |
| k_{ω}_{ₓ} | none | 1.0 | 0.1 | 1.0212 | 1.0198 |
| k_{ω}_{_{y}} | none | 1.0 | 0.1 | 1.0266 | 1.0232 |
| k_{ω}_{_{z}} | none | 1.0 | 0.1 | 1.0218 | 1.0215 |
| b_{ω}_{ₓ} | °/s | 0.0 | 5.0 | −0.1295 | −0.1274 |
| b_{ωa}_{_{y}} | °/s | 0.0 | 5.0 | −0.1505 | −0.1431 |
| b_{ω}_{_{z}} | °/s | 0.0 | 5.0 | −0.0572 | −0.0597 |

— indicates a parameter which could not be calibrated.
* indicates a parameter which was not included in standard comparison methods.
See Section X (Discussion) for details.

Trajectory optimization (see, T. Qin, P. Li, and S. Shen, “Vins-mono: A robust and versatile monocular visual-inertial state estimator,” IEEE Transactions on Robotics, vol. 34, no. 4, pp. 1004-1020, 2018, the disclosure of which is hereby incorporated by reference in its entirety) and calibration of the system (see, H. M. Le, T. N. Do, and S. J. Phee, “A survey on actuators-driven surgical robots,” Sensors and Actuators A: Physical, vol. 247, pp. 323-354, 2016, the disclosure of which is hereby incorporated by reference in its entirety) both require knowledge of the covariance matrices Σ_{zj} associated with the IMU measurements. Here, the standard assumption that the measurements are not correlated is applied again. Additionally, it is assumed that the covariance is constant during robot motion, i.e., Σ_{z}_{₁}= . . . =Σ_{z}_{_{N}}=Σ_{z}.

While Σ_{z} can be estimated by sampling the IMU under static conditions, in our experiments, we found the measurement noise to be significantly greater when the robot is moving. Therefore, to determine Σ_{z} we moved the robot-IMU setup (see FIG. 12) dynamically while sampling the IMU. The samples z, collected over 300 seconds, were then least-squares fit to a spline function (see Eq. 20). The errors between the fit and the data were then used to compute the covariance Σ_{z}=diag[0.38² 0.21² 0.19² 0.32² 0.47² 0.57²] where the first three elements, corresponding to specific force variance, have units of (m/s²)² and the last three elements have units of (°/s)² and represent angular velocity variance. Using similar methods and assumptions, the constant, diagonal covariance of the measured joint values is determined to be:

Σ_{q}=diag[0.0038² 0.0050² 0.0043² 0.0105² 0.0101² 0.0086²](°)².

FIG. 12. Illustrates the experimental setup to test the calibration method's ability to improve accuracy of the robot and sensor models. An aluminum plate with a Bosch BNO055 IMU and optical tracking spheres is mounted to the end effector of an AUBO i5 industrial collaborative robot. The NDI Polaris Vega optical tracker is used for ground truth data acquisition only to evaluate the calibration method's ability to improve robot and sensor accuracy.

### B. Planned Trajectory Optimization

In order to proceed with any of our other experiments, first we must choose the planned trajectory for the robot to follow during data collection. Here we discuss the details of implementing our trajectory optimization method (Section VII) with our particular robot-IMU setup. After optimization, we compare the performance of the optimal trajectory to a random trajectory of the same length to determine the performance gain by using the optimal trajectory.

We generated a 300 second trajectory using our recursive method outlined in Section VII. To build the matrices in Eq. 31, we assumed a sample rate for the IMU and the joint values of 120 Hz as this was approximately the value achieved by our system. For the trajectory representation, we chose to use a spline of degree d=3 with one interior knot per second. This leads to a C having 303 columns in total. Taking into account the known padding blocks C₀ and C_{N}_{ₛ₊₁}, this leads to 297 columns of C to determine. We used a block size of N_{c}=5 columns per iteration. Given the 6 axis robot model, this leads to solving Eq. 33 for Nₛ=60 iterations to determine the 1782 unknown elements of C. In order to constrain the motion (Eq. 28) within safe operating conditions, the joint limits shown in Table 3 were used:

TABLE 3
Robot Joint Position, Velocity, and
Acceleration Limits for Experiments

| | | |
|---|---|---|
| Position | Velocity | Acceleration |
| Limits (°) | Limits (°/s) | Limits (°/s²) |

| Joint | Min | Max | Min | Max | Min | Max |
|---|---|---|---|---|---|---|
| 1 | −90 | 90 | −10 | 10 | −100 | 100 |
| 2 | −75 | 75 | −10 | 10 | −100 | 100 |
| 3 | 30 | 120 | −10 | 10 | −100 | 100 |
| 4 | −175 | 175 | −25 | 25 | −100 | 100 |
| 5 | −90 | 90 | −25 | 25 | −100 | 100 |
| 6 | −175 | 175 | −25 | 25 | −100 | 100 |

Note that these values are chosen conservatively to maintain safe operating trajectories.

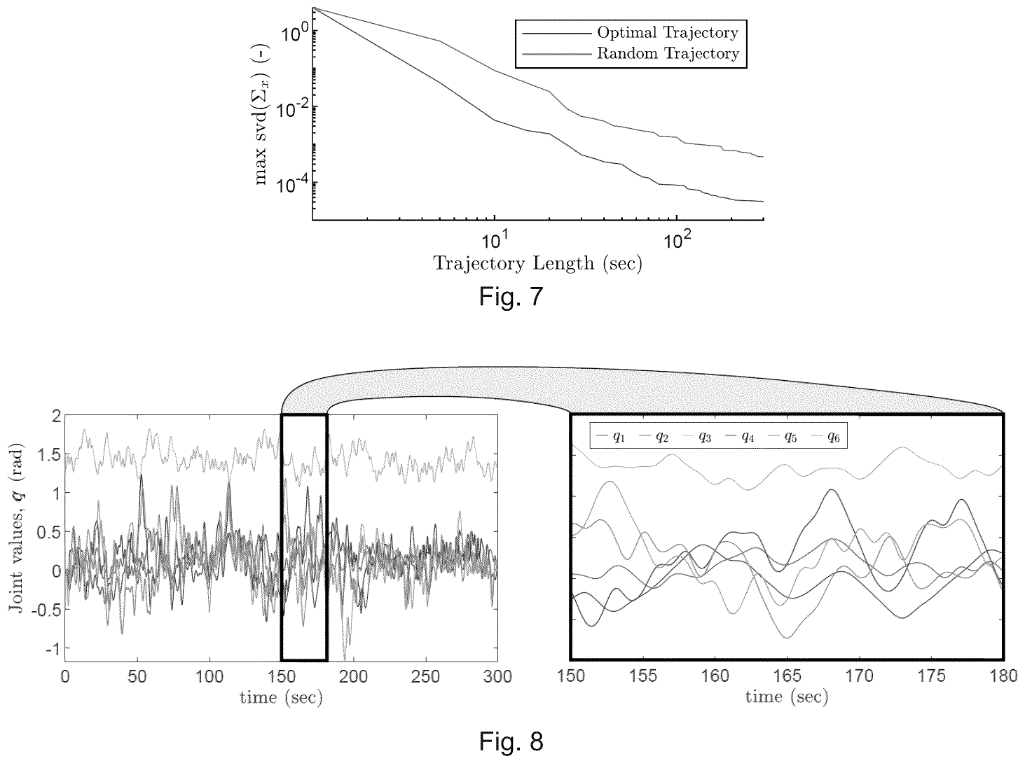

During each iteration, a hybrid global optimization method was used to solve Eq. 33 for the 30 elements of C*ⱼ. First, 2000 iterations of the simulated annealing algorithm were ran (implemented in MATLAB's simulannealbnd function) to determine Cⱼ globally. This was followed by a local refinement step using the Hooke's-Jeeves pattern search algorithm (as implemented in MATLAB'S patternsearch function) with 200 iterations, a maximum mesh size of 0.5, and compete polling. The optimal trajectory generated is shown in FIG. 7, which illustrates the observability-optimal trajectory generated for the AUBO i5 industrial arm. The 5 minute trajectory is parameterized by 1818 B-spline coefficients. Solving for these optimal coefficients in the experiments directly was not computationally feasible. Use of the disclosed fast, sequential trajectory optimization method, however, made solutions possible.

The trajectory performance measure (Eq. 33) is shown decreasing with time in FIG. 8, which shows the observability of the robot-IMU system parameters versus trajectory length. Compared with a random trajectory of the same length, the optimal trajectory generated by our sequential trajectory optimization method reduced the observability measure by at least an order of magnitude. This suggests that parameter estimates are 3-4 times more precise in the numerical experiments when using an optimal trajectory. Also shown here is the same observability measure computed using a random trajectory as opposed to the optimal trajectory. This random trajectory was determined by selecting uniformly random values for the matrix C while still adhering to the trajectory constraints (see Eq. 28).

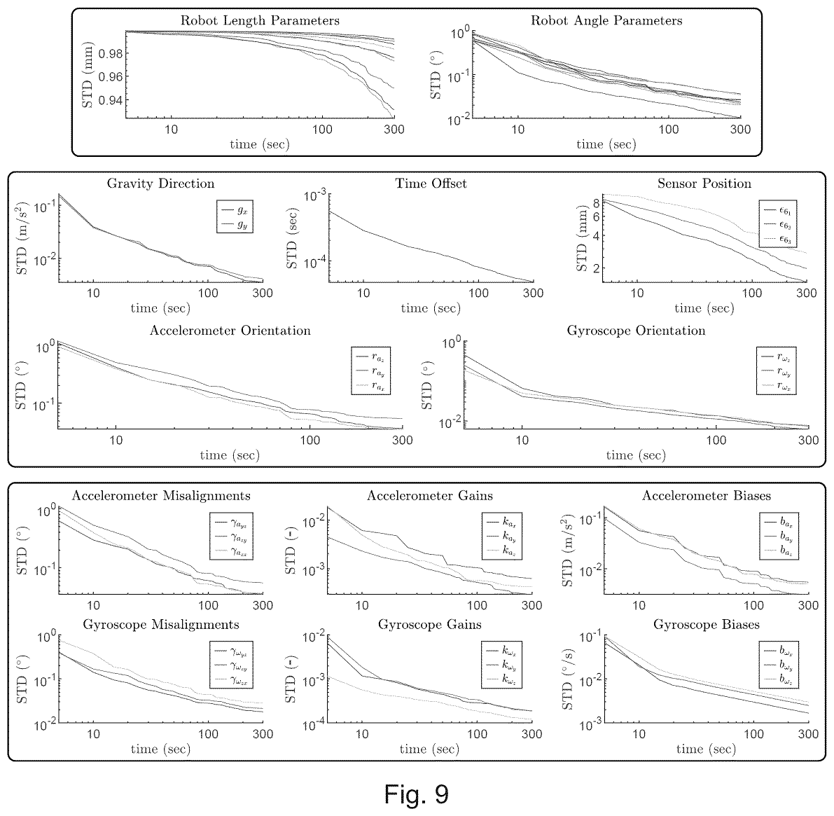

Additionally, using the relationship of Eq. 32, the posterior standard deviations (the square roots of the diagonals of Σₓ_{ⱼ}) of all of the parameters in x were computed. These are plotted versus time in FIG. 9, which shows robot kinematic error parameters ∈ (top); extrinsic system parameters g_{xy}, τ, rₐ, and r_{ω} (middle); and IMU sensor parameters γₐ, kₐ, bₐ, γ_{ω}, k_{ω}, and b_{ω} (bottom). The estimation precision of all parameters improves with trajectory length for this particular system. To verify the approximation of Eq. 26, the approximate covariance Σₓ was compared to the covariance predicted by the estimator of Eq. 24. After the full trajectory, the Frobenius norm between the two covariances was 4.7e−6.

### C. Monte Carlo Simulations

To verify the observability of the parameters θ=[x^{T} c^{T}]^{T} under our assumptions, we performed a series of Monte Carlo simulations. In each of the simulations, data was generated using ground truth parameters, noise was injected into the data, and then Eq. 22 was solved using the noisy data to estimate the true parameters. In the following we describe this process for a single iteration.

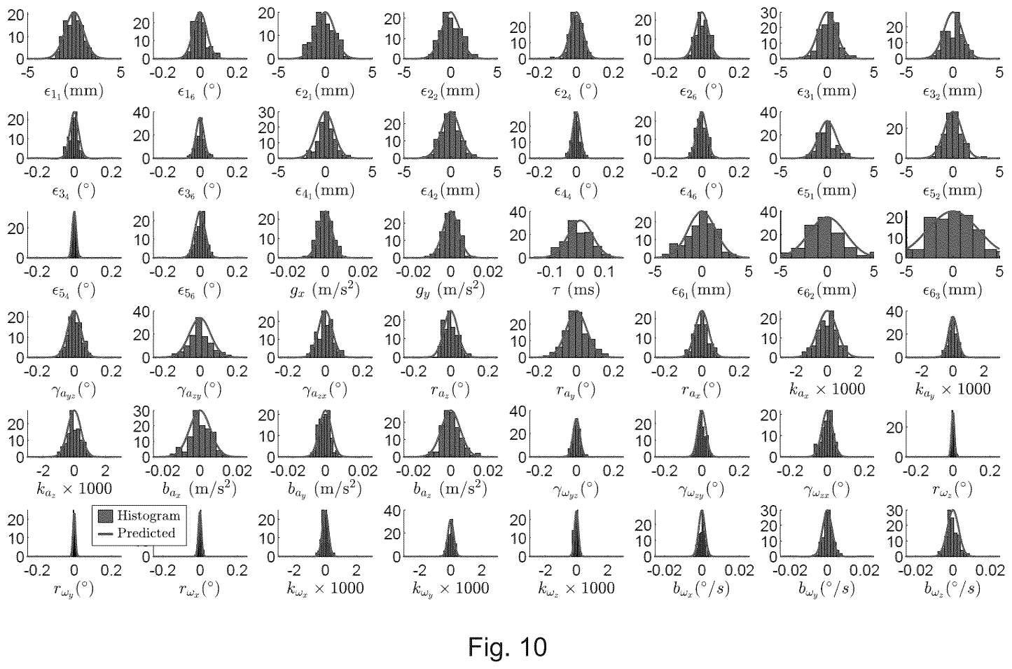

First, the ground truth set of parameters were sampled using the nominal values and standard deviations shown in Table II. Next, using the optimal trajectory C*, the ground truth parameters, and the determined covariances Σ_{z} and Σ_{q}, the required data qᵢ and zᵢ for i=1 . . . N is generated using Eq. 10. Using these measurements along with the nominal parameters as an initial guess, the estimate (Eq. 22) and the posterior covariance (Eq. 24) of the parameters θ. This process was repeated for 100 simulations, and estimation errors for x are shown in FIG. 10 via histograms of errors between the 48 estimated and ground truth system parameters x in the 100 Monte Carlo simulations. The red lines indicate the posterior distributions predicted by the estimator (i.e., Eq. 24) which match closely with the histogram data.

### D. Robot Length Parameter Identifiability

As discussed in Section X, the numerical results indicate that for the particular setup, robot length parameters (e.g., link lengths) cannot be estimated with much certainty. It is hypothesized that restrictions on robot joint speeds and accelerations (see Table III) could affect identifiability of robot length parameters. Here a numerical experiment is performed, analyzing the effect of trajectory speed on length parameter identifiability.

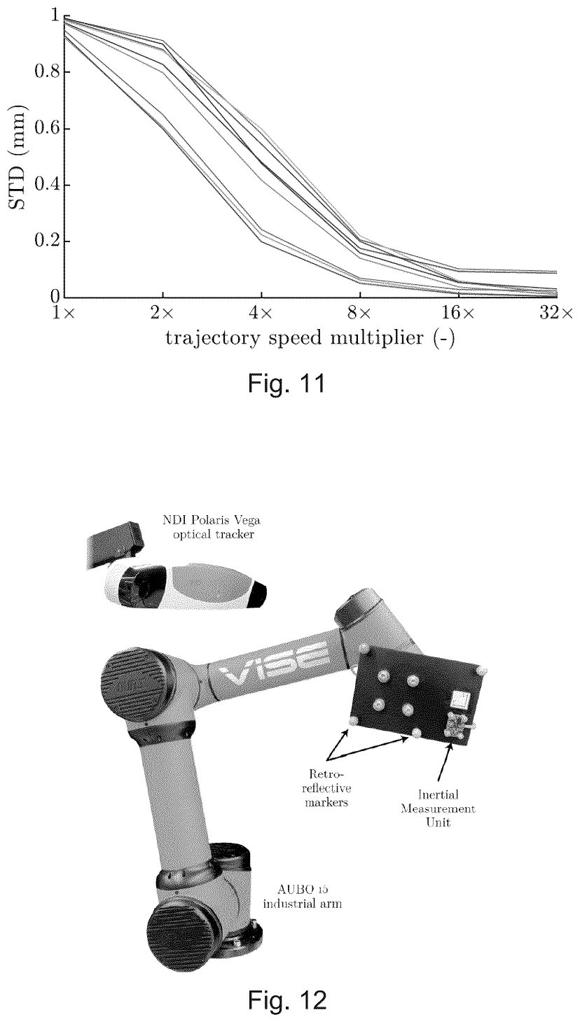

The generated 300 second optimal trajectory was then used to define several faster trajectories. This was done by scaling the X-axis by different amounts so that the original trajectory was completed in less time. In this way, 5 new trajectories were created: one that was 2× faster than the original, one 4x, one 8x and so on. Using Eq. 26, the posterior standard deviations of the robot length parameters were computed for each of the different trajectory speeds. We adjusted the 120 Hz sample rate to achieve the same number of data samples for each trajectory (e.g. 240 Hz for the 2× trajectory). Posterior uncertainty of robot length parameters is shown decreasing with trajectory speed in FIG. 11.

In FIG. 11, predicted posterior standard deviations of the 9 robot length parameters (e.g., link lengths) versus trajectory speed. As the speed of robot motion increases, the precision on length parameters improves substantially. While our robot's motion was bounded by the values in Table 3, faster robots could enjoy accurate length parameter calibration with the disclosed method.

### IX. Experimental Results

To verify the ability of the disclosed method to increase robot accuracy and sensor accuracy, we performed a set of experiments testing our method with an AUBO i5 collaborative industrial arm with an end effector-mounted Bosch BNO055 9-axis orientation sensor (see FIG. 12). Additionally, an NDI Polaris Vega optical tracker was used to measure the accuracy of the robot and the sensors. With the tracker, “standard” calibrations of both the robot and the IMU were performed separately for comparison with the estimated values. Note that the optical tracker was used for verification purposes only.

The aluminum plate mounted to the end-effector flange served to hold the retro-reflective markers (for optical tracking) and the IMU board rigid with respect to the robot's end effector. The IMU reported its samples to an Arduino Mega microcontroller using the I²C digital communication protocol. Software was written to command the robot along the desired optimal trajectory. Additionally, separate data collection software was written to simultaneously record the robot's joint values (via MATLAB's ROS toolbox) and the IMU sensor readings (via MATLAB'S serial interface).

The robot was first commanded along the optimal trajectory while recording its joint values and the sensor readings on a separate PC. This information was then used to infer θ and thus the model parameters x using Eq. 22. The resulting values are shown alongside their nominal counterparts in Table 2. Based on the results of our numerical experiments in Section VIII, in real experiments, the choice was made to exclude robot length parameters from the calibration. This was achieved by setting their prior covariances to small numbers so that they would not be updated by calibration. Therefore, only the updated robot angle parameters are shown in Table 2. This limitation of our method is discussed thoroughly in Section X.

Following the identification procedure, we began the robot accuracy evaluation process. The robot was next commanded to 250 discrete configurations for robot accuracy evaluation. Once at a configuration, the pose of the end effector was sampled for 3 seconds. The poses at a particular configuration were then averaged using the quaternion-based rotation averaging algorithm (see, F. L. Markley, Y. Cheng, J. L. Crassidis, and Y. Oshman, “Averaging quaternions,” Journal of Guidance, Control, and Dynamics, vol. 30, no. 4, pp. 1193-1197, 2007, the disclosure of which is hereby incorporated by reference in its entirety).

To verify our method's ability to identify robot parameters, we performed a standard robot calibration (see Meggiolaro and Dubowsky, cited above) using 150 of the 250 collected poses. Note that, because the method could not calibrate length parameters accurately in the experimental setup, length parameters were also excluded in the standard calibration. The standard calibration values are shown alongside calibrated values in Table 2. The constant transforms T_{robot}^{tracker} and T_{end effector}^{markers} lend effector necessary for evaluating robot accuracy were then extracted from the standard calibration.

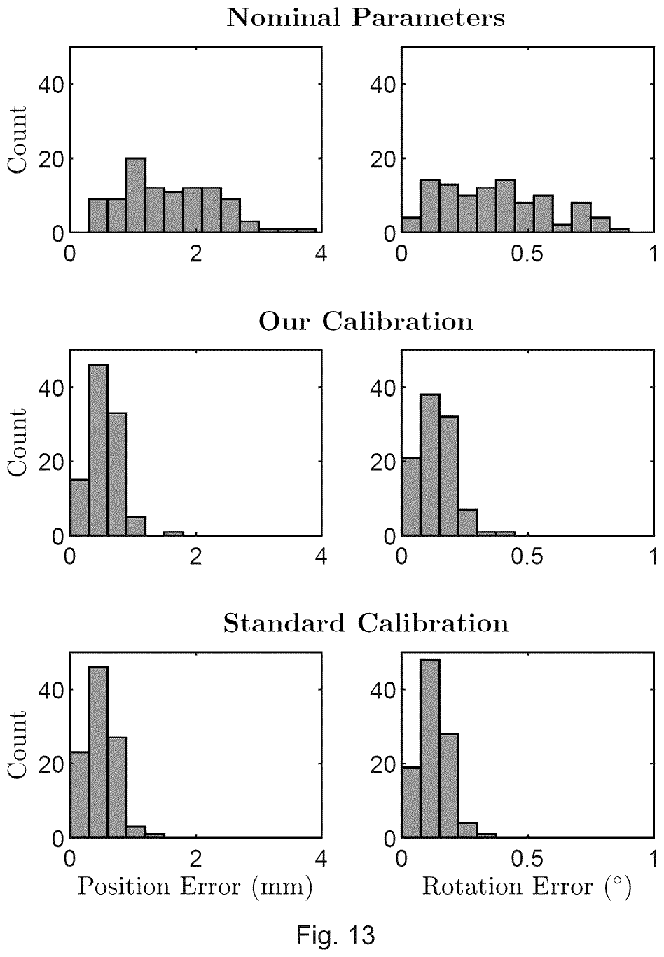

To test the method's ability to improve robot accuracy, the remaining 100 poses were used to compute accuracy using nominal parameters, actual calibration parameters, and the standard calibration parameters. The positional accuracy was computed using the standard Euclidean norm between the tracker-measured and model predicted end effector positions. The rotational accuracy was taken as the standard minimal geodesic distance between the measured and predicted end effector rotations, Rₘₑₐₛ and R_{pred}. In other words, the rotation error is defined as the angle of the rotation Rₘₙₑₐₛ^{T}Rₘₑₐₛ. These robot translation and rotation accuracy results are shown in FIG. 13.

FIG. 13 shows histograms illustrating both position and rotation robot accuracy before calibration (top), after calibration according to the method disclosed herein (middle), and after a standard calibration (bottom). Accuracy is evaluated by comparing the model-predicted end effector pose to the optically-tracked ground truth.

To verify our method's ability to identify IMU parameters, we performed a standard IMU calibration using the optical tracker (see A. Kim and M. Golnaraghi, “Initial calibration of an inertial measurement unit using an optical position tracking system,” in PLANS 2004. Position Location and Navigation Symposium (IEEE Cat. No. 04CH37556). IEEE, 2004, pp. 96-101, the disclosure of which is hereby incorporated by reference in its entirety). The setup was manipulated along a random 20 minute trajectory while recording both tracker-based pose and raw IMU data. These data together were used for IMU calibration. Note that the angular parameters relative to the end effector were not included in the standard IMU calibration which was relative to the tracked markers. The standard calibration values are shown alongside our calibration values in Table 2.

In addition to improving the robot accuracy, our method should improve the accuracy of the IMU sensors. Immediately after running the optimal calibration trajectory, a different random 120 second trajectory was run to evaluate the accuracy of the IMU sensors. During this process, the pose of the end effector was measured using the optical tracker for evaluation purposes. Given the alignment of the end-effector with the markers (known from the standard robot calibration above) and the alignment of the end-effector with the IMU (known from our calibration), the tracked pose of the IMU was computed. Splines of degree 5 and one interior knot per 30 samples were fit to the IMU position and quaternion data. These spline functions were differentiated to obtain ground truth IMU acceleration and angular velocity functions. The ground truth specific force was then computed from the acceleration data using the estimated gravity direction vector from the calibration gry. In order to assess IMU calibration accuracy relative to the tracker data, the tracker must first be temporally aligned with the IMU. To accomplish this, first the tracker was temporally aligned with the robot data using a subset of the trajectory. Then the required tracker/IMU temporal alignment is just the sum of this tracker/robot alignment and the estimated robot/IMU alignment t in Table 2. Using the temporal offsets, the ground truth specific forces and angular velocities were evaluated at the same time of the IMU samples and then transformed into the accelerometer and gyroscope coordinate systems respectively.

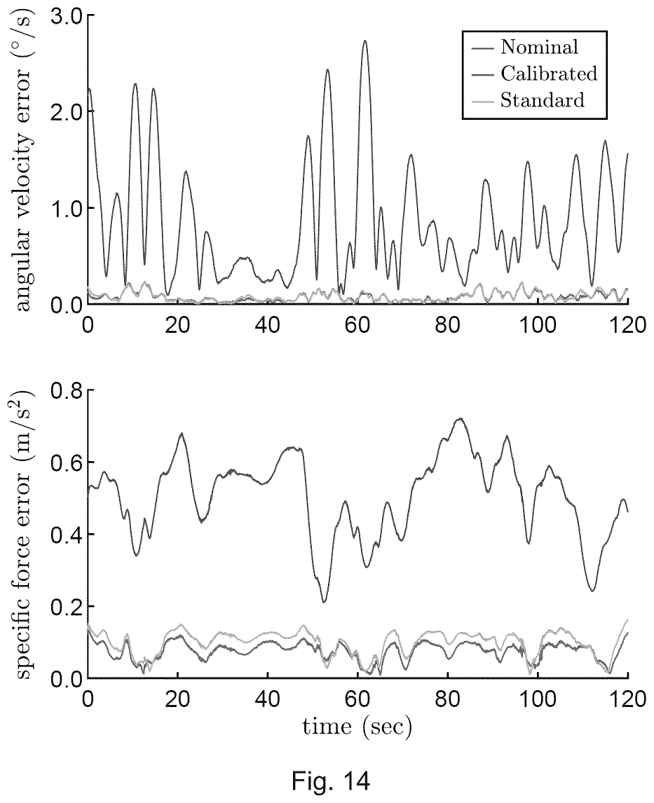

The accelerometer and gyroscope IMU outputs were computed using the inverse of Eq. 6 using nominal sensor parameters and our calibration parameters, and the standard calibration parameters. The normed differences between the sensor outputs and the ground truth inertial quantities measured with the tracker are shown in FIG. 14 where a moving mean filter is applied with a window size of 500 samples. In FIG. 14, histograms showing both specific force and angular velocity sensor accuracy before calibration (blue), after calibration according to the method disclosed herein (red), and after a standard calibration. Accuracy is evaluated by comparing the sensor model predicted values to the optically-tracked ground truth. Note that data has been passed through a moving mean filter with a 500 sample window.

### X. Discussion

Numerical experiments indicate that, for the particular IMU-robot arrangement disclosed herein, the system is observable. In optimal trajectory experiments (see FIG. 9), all of the parameters' STDs were reduced by calibration, and the identification Jacobian was found to be full rank and well-conditioned over the calibration trajectory. Furthermore, the Monte Carlo simulations indicate that, given all assumptions about the system and associated noise profiles, the disclosed calibration converges to the correct values. This indicates that the IMU and joint angle measurements provide enough information to infer x for the disclosed setup at least in principle. The disclosed system employed a non-redundant manipulator; and it is noted that the results may not directly apply for a redundant setup and leave redundant robot/IMU calibration for future work. Furthermore, if observability is ever a problem for a specific setup, the disclosed Bayesian approach to parameter estimation ensures the existence of nonsingular solutions. In the case that the measurements cannot provide information about a particular set of parameters, their marginal prior and posterior distributions will be the same.

This is the extreme case of the results for the robot length parameters. The numerical results suggest that the length parameters in e are observable. This can be seen in FIG. 9 where all of the predicted STDs of the robot length parameters were reduced given the measured data. However, while the angle parameter uncertainties were all reduced by at least a factor of ten, calibration only changed the length parameter uncertainties marginally. This suggests that, in this particular setup, calibration of the robot length parameters—while mathematically possible—is not practically feasible. For these reasons, it was decided not to include the robot length parameters as calibration variables in the real experiments.

The identifiability of the robot length parameters could be improved with a longer trajectory, however, this comes with additional time and computation costs. As only the accelerometer measurements can give robot length parameter information, the lengths could be identified more accurately by improving the accelerometer signal to noise ratio. As mentioned previously, accelerometer noise was dominated by the vibrations of the system during trajectory following; therefore, we believe that using a higher fidelity IMU is unlikely to make a large difference. Instead, we propose that it is more practical to improve robot length parameter identifiability by utilizing faster robot trajectories. The real experiments were limited to the motion constraints in Table 3. The numerical experiments (see FIG. 11), however, suggest that the identifiability of robot length parameters can be significantly improved with faster trajectories. Application of our method to high-speed robots for full Level II calibration (both length and angle parameters) could be the basis for future work (see Z. Roth, B. Mooring, and B. Ravani, “An overview of robot calibration,” IEEE Journal on Robotics and Automation, vol. 3, no. 5, pp. 377-385, 1987, the disclosure of which is hereby incorporated by reference in its entirety).

The problem proposed in this disclosure requires long robot trajectories in order to acquire enough information for a good calibration. Thus, trajectory optimization was used to ensure information richness of the robot motion, ultimately enabling shorter trajectories. Traditionally, trajectory optimization involves computing the entire optimal trajectory all at once. In numerical experiments, this approach led to an inequality-constrained, nonlinear optimization problem in 1782 variables. Due to this size and complexity, a solution was not feasible on a common PC platform.

Alternatively, the sequential approach to trajectory optimization makes planning of such long, observability-optimal trajectories feasible by splitting the large-scale problem into many simpler ones. As shown in FIG. 8, the trajectory optimization method significantly improved the observability of the system parameters x. The optimal trajectory yielded a posterior covariance of x with a maximum singular value of 3.1e−05, whereas the random trajectory yielded a value of 4.6e−04. This implies that the posterior STDs are bounded by 0.0056 and 0.0215 respectively. Therefore, compared with a random trajectory, the optimal trajectory made the calibration 3.8 times more accurate for our system. It is noted that, based on FIG. 8, adequate results are eventually possible with a random trajectory. In the experiments, however, an optimal trajectory is more efficient, achieving the same level of precision in less time.

Monte Carlo simulations (see FIG. 10) validates the method, given all assumptions about the system and the noise profiles of the sensors. Specifically, these results verify the approximation of Σₓ in the trajectory optimization method. As shown in FIG. 10, all of the predicted distributions based on the approximation of Eq. 26 matched closely with the histograms output by the Monte Carlo simulations. Therefore, we can assume the approximation of Σₓ in Eq. 26 to be reasonably accurate for our system.

Real experiments show that the method works in practice to identify robot angle parameters. In Table 2, the average and maximum error between the identified angle parameters and the standard calibration was 0.04° and 0.09°, respectively. The method also significantly improved robot accuracy. This is shown in FIG. 13 by the error reduction of both the position and rotation model predictions. Before calibration, the mean position accuracy was 1.58 mm. The calibration reduced this metric to 0.55 mm, near the 0.49 mm obtained by the standard calibration. Rotation accuracy was also improved by the method bringing the mean accuracy from 0.37° down to 0.13°, very near the 0.13° achieved by the standard calibration.

All of this suggests that our method is comparable to a standard robot calibration for estimating angle parameters. Thus, our approach offers a cheap and fast Level I robot calibration (i.e., calibration of the joint angle offsets, see Roth, Mooring, and Ravani, cited above) as well as a partial Level II robot calibration (i.e., calibration of the entire rigid kinematics model). As previously noted, full Level II calibration could even be achieved given a sufficiently fast robot trajectory (see FIG. 11), but this was not possible in the specific setup. The incapability of the method to estimate link lengths in the specific setup is likely not a large concern as an accuracy of 0.55 mm is adequate for most applications. Furthermore, it has previously been shown that for industrial arms, the majority of positional error is actually caused by errors in joint angle offsets rather than the other kinematic parameters (see P. Shiakolas, K. Conrad, and T. Yih, “On the accuracy, repeatability, and degree of influence of kinematics parameters for industrial robots,” International journal of modelling and simulation, vol. 22, no. 4, pp. 245-254, 2002, the disclosure of which is hereby incorporated by reference in its entirety).

In addition to robot angle parameter calibration the disclosed method also provides an IMU sensor calibration. All of the calibrated values match reasonably well with the standard IMU calibration in Table 2. The disclosed method also substantially improved the accuracy of the IMU sensors. Both angular velocity and specific force errors were reduced when compared to the optically tracked ground truths (see FIG. 14). Specifically, over the 60 second evaluation trajectory, the angular velocity errors were reduced from 2.17°/s to 0.95°/s in the RMS sense. The standard calibration also achieved 0.95°. For the accelerometers, specific force errors were reduced from 0.93 m/s² to 0.77 m/s² in the RMS sense; the standard calibration also achieved 0.77 m/s².

All of this suggests that the disclosed method is comparable to a standard IMU calibration. Based on these results, and given that the disclosed method could be used with multiple IMUs at once, it is believed that the method could be useful in cases where many IMU sensors need to be calibrated quickly, such as in a sensor manufacturing facility.

Finally, based on the Monte Carlo simulation, the disclosed method also accurately estimates all of the extrinsic parameters of the IMU (i.e., spatial offset, temporal offset, and gravity). This makes the disclosed method ideal as an initial calibration step enabling the use of IMU data in online robot estimation and monitoring applications.

### XI. Conclusion

In this disclosure, a new method for jointly estimating robot kinematic parameters, inertial sensor parameters, and various extrinsic parameters relating the two (spatial offsets, temporal offsets, and gravity) is described. Testing and evaluation of the method is also described. Utilizing advancements in continuous-time batch trajectory estimation, the disclosure shows that the maximum a posteriori estimate leads to a nonlinear least squares problem and derives the sparsity structure of the associated Jacobian. Additionally, as long robot trajectories were required to achieve a good calibration, a new method is disclosed to generate observability-optimal trajectory plans sequentially, building the trajectory piece-by-piece. In the disclosed application, the results suggest that it achieves estimates that were many times more precise than a random trajectory. Note that generalization of the sequential trajectory optimization approach to many other estimation scenarios (e.g., robot dynamic identification See J. Swevers, C. Ganseman, D. B. Tukel, J. De Schutter, and H. Van Brussel, “Optimal robot excitation and identification,” IEEE transactions on robotics and automation, vol. 13, no. 5, pp. 730-740, 1997 and K.-J. Park, “Fourier-based optimal excitation trajectories for the dynamic identification of robots,” Robotica, vol. 24, no. 5, p. 625, 2006, the disclosures of which are hereby incorporated by reference in their entireties) is straightforward. Using this optimal trajectory, the unified calibration approach in a Monte Carlo simulation was evaluated, showing that the calibration produces the correct result on average. The numerical results also suggest a strong link between trajectory speed and robot length parameter identifiability. While length parameters could not be accurately estimated in the particular setup used in testing, application of the method to high-speed robots for full kinematic calibration could be the basis of future work.

The disclosed method improved the accuracy of the robot in experiments substantially, suggesting a potential application in Level I robot calibration (i.e., determining joint angle offsets) as well as a partial Level II robot calibration (i.e., calibration of the entire rigid kinematics model). Furthermore, the method significantly reduced inertial sensor errors when compared to a ground truth showing promise for an alternative method of IMU sensor calibration. Additionally, experiments show that the method is comparable to standard methods for robot and IMU calibration. Based on the Monte Carlo simulation, the method also accurately estimated the extrinsic parameters of the IMU (i.e., the IMU translation, rotation, and temporal offset relative to the robot). This makes the method ideal as an initial calibration step enabling the use of IMU data in online robot estimation and monitoring applications.

From the above description of the invention, those skilled in the art will perceive improvements, changes, and modifications. Notwithstanding such improvements, changes, and modifications, simply stated, the systems and methods disclosed herein can be applied to any robotic structure where knowledge of a precise location of the robot or any portion thereof is desired. According to the systems and methods disclosed herein, a recursive estimation algorithm can be implemented to fuse robot encoder values with IMU data to determine a statistically optimized estimated position of the robot, regardless of the robot's configuration and/or construction. Such improvements, changes and modifications within the skill of the art are intended to be covered by the appended claims.

We claim:

1. A robotic system comprising:
a robot comprising a working portion configured to undergo robotic movement;
a controller configured to command the operation of one or more actuators according to encoder values to cause the robotic movement in order to control the position the working portion; and
an inertial measurement unit (IMU) configured to sense physical movements and to provide IMU data to the robot controller indicative of the sensed physical movements, the IMU being fixed to the working portion of the robot;
wherein the controller is configured to fuse the encoder values with the IMU data to determine an estimated position of the robot.

2. The robotic system recited in claim 1, wherein:
the robot comprises a robot arm with a plurality of links interconnected at joints so that the links can move relative to each other;
the working portion comprises a portion of the robot arm;
the operation of the actuators causes the links to articulate in order to control the position the robot arm;
the IMU is fixed to the robot arm; and
the estimated position of the robot comprises an estimated position of the robot arm.

3. The robotic system recited in claim 2, wherein the working portion comprises a tip of the robot arm.

4. The robotic system recited in claim 2, comprising multiple IMUs fixed to the robot arm at different locations.

5. The robotic system recited in claim 4, wherein an IMU is fixed to each link.

6. The robotic system recited in claim 2, wherein the joints comprise resolute joints.

7. The robotic system recited in claim 2, wherein the joints comprise prismatic joints.

8. The robotic system recited in claim 2, further comprising linkages connected to the links and the actuators, wherein the actuators are configured to manipulate the linkages in order to cause the links to move via the joints.

9. The robotic system recited in claim 8, wherein the linkages comprise at least one of cables, tendons, belts, gear trains, clutches, and linear actuators.

10. The robotic system recited in claim 2, wherein the robot comprises a serial robot.

11. The robotic system recited in claim 1, wherein:
the robot comprises a movable member supported on a base by a plurality of actuators, the movable member being movable by the actuators relative to the base;
the working portion is supported on and movable with the movable member;
the operation of the actuators causes the movable member to articulate in order to control the position of the movable member; and
the estimated position of the robot comprises an estimated position of the movable member.

12. The robotic system recited in claim 11, wherein the working portion is supported on the movable member.

13. The robotic system recited in claim 11, further comprising an IMU fixed to the movable member.

14. The robotic system recited in claim 11, wherein the actuators comprise prismatic joints.

15. The robotic system recited in claim 11, wherein the robot comprises a parallel robot.

16. The robotic system recited in claim 1, wherein the controller is configured to implement a recursive estimation algorithm configured to fuse the encoder values with the IMU data.

17. The robotic system recited in claim 16, wherein the recursive estimation algorithm is configured to statistically optimize the estimated position given the most recently obtained encoder values and IMU data and a previous best estimate of the estimated position.

18. The robotic system recited in claim 16, wherein the recursive estimation algorithm comprises a filter configured to fuse the encoder values with the IMU data.

19. The robotic system recited in claim 18, wherein the filter comprises a variable trust statistical filter that produces an estimated position of the working portion.

20. The robotic system recited in claim 18, wherein the filter is configured to bias the estimated position based on at least one of historical data and task-specific information comprising sensor noise, calibration, operating conditions, and past performance.

21. The robotic system recited in claim 16, wherein the controller is configured to execute the algorithm on an iterative basis in real-time to produce the estimated position in real-time.

22. The robotic system recited in claim 21, wherein the estimated position for a current iteration of the algorithm is biased based on an estimated position from a previous iteration of the algorithm.

23. The robotic system recited in claim 18, wherein the filter comprises a Kalman filter or a particle filter.

24. The robotic system recited in claim 1, wherein the working portion comprises an ultrasound probe secured to the robot arm, the IMU being fixed to the ultrasound probe.

25. The robotic system recited in claim 1, wherein the controller is configured to calibrate the encoder values with the IMU data by moving the working portion in open space free from interference from outside structures, wherein the IMU data is presumed accurate and is used to calibrate the encoder values in response to detecting a difference between the encoder values and the IMU data.
